(19) United States
(12) Patent Application Publication
(10) Pub. No.: US 2012/0277123 A1
(43) Pub. Date: Nov. 1, 2012

(54) APPARATUS AND METHOD FOR MANUFACTURING MICROARRAY BIOCHIP

(75) Inventors: Sheng-Li Chang, Hsinchu County (TW); Hann-Wen Guan, Taoyuan County (TW); Kuo-Chi Chiu, Hsinchu County (TW); Chu-Yu Huang, Taichung City (TW)

(73) Assignee: INDUSTRIAL TECHNOLOGY RESEARCH INSTITUTE, Hsinchu (TW)

(21) Appl. No.: 13/183,457

(22) Filed: Jul. 15, 2011

(30) Foreign Application Priority Data
Apr. 28, 2011 (TW) 100114915

(51) Int. Cl. C40B 50/00; C40B 60/14

(52) U.S. Cl. 506/23; 506/40

(57) ABSTRACT

An apparatus of manufacturing a microarray biochip including a spinning platen, at least one carrier and at least one substrate is provided. The carrier is disposed on the spinning platen and includes at least one micro-channel having an input terminal and an output terminal. The substrate is attached on the output terminal of the micro-channel of the carrier. A method of manufacturing a microarray biochip with said apparatus is also provided. A sample is injected into the micro-channel through the input or the output terminal. The spinning platen is powered-on to provide a centrifugal force to the carrier, such that the sample is flowed toward the output terminal from the input terminal, and then is immobilized on the surface of the substrate.

### CROSS-REFERENCE TO RELATED APPLICATION

This application claims the priority benefit of Taiwan application serial no. 100114915, filed Apr. 28, 2011. The entirety of the above-mentioned patent application is hereby incorporated by reference herein and made a part of this specification.

### BACKGROUND OF THE DISCLOSURE

1. Technical Field

The disclosure relates to an apparatus and a method for manufacturing a microarray biochip.

2. Description of Related Art

A biochip can be used to simultaneously detect performances of hundreds or even thousands of genes or proteins to select significant genes or proteins. Moreover, based on a deoxyribonucleic acid (DNA) chip technique, a large amount of target genes can be quickly found, and a gene probe or a so-called reporter gene is developed to establish molecular images. Therefore, the biochip can be a very important biomedical research tool in the future.

Generally, the biochip refers to that biology-related molecules (for example, genes, proteins, carbohydrates or cells, etc.) are precisely spotted on a chip through a high-precision fabrication technique. Two types of chips including genetic chips and protein chips are divided according to different substances spotted on the chip. Generally, after liquid containing biological molecules is spotted on the chip through various spotting methods, a long period time is generally required to immobilize the biological molecules on the chip. This is because that the biological molecules in the liquid bead contact the chip surface through free diffusion and free deposition. Therefore, adequate time is required to ensure an enough amount of the biological molecules to be immobilized on the chip. Moreover, according to such free contact immobilization method, not only distribution of the biological molecules in a spotting area is uneven, but also a unit density of the biological molecules is not high, so that detection sensitivity and accuracy of the biochip are decreased, which is a problem commonly faced by various fabrication methods. Meanwhile, since the conventional spotting apparatus requires a high-precision mobile platform and a high-precision control system, the cost thereof is high, which is one of the reasons of the high manufacturing cost.

### SUMMARY

The disclosure provides an apparatus of manufacturing a microarray biochip, which comprises a spinning platen, at least one carrier and at least one substrate. The carrier is fixed on the spinning platen and comprises at least one micro-channel having an input terminal and an output terminal. The substrate is attached to the output terminal of the micro-channel of the carrier.

The disclosure provides a method of manufacturing a microarray biochip comprising following steps. At least one carrier is provided, where the carrier comprises at least one micro-channel, and the micro-channel has an input terminal and an output terminal. At least one substrate is attached to the output terminal of the micro-channel of the carrier. A sample is injected into the micro-channel through the input terminal or the output terminal of the carrier. The carrier and the substrate are fixed to a spinning platen. The spinning platen is powered-on to provide a centrifugal force to the carrier, such that the sample is flowed towards the output terminal from the input terminal, and then is immobilized on a surface of the substrate.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an apparatus of manufacturing a microarray biochip according to an exemplary embodiment of the disclosure.

FIG. 2 is a schematic diagram of a carrier according to an exemplary embodiment of the disclosure.

FIGS. 3A-3F are schematic diagrams of micro-channels in a carrier according to a plurality of exemplary embodiments.

FIG. 4 is a schematic diagram of an apparatus of manufacturing a microarray biochip according to an exemplary embodiment of the disclosure.

FIGS. 5A-5B are schematic diagrams of using the apparatus of FIG. 1 to manufacture a microarray biochip.

FIG. 5C is a schematic diagram of a microarray biochip manufactured by the apparatus of FIG. 1.

FIG. 6A and FIG. 6B are schematic diagrams illustrating a flow of manufacturing a microarray biochip according to an exemplary embodiment of the disclosure.

FIG. 7 is a schematic diagram of a carrier according to another exemplary embodiment of the disclosure.

FIGS. 8A-8E are exploded views of the carrier of FIG. 7.

FIG. 9A and FIG. 9B are schematic diagrams illustrating a flow of manufacturing a microarray biochip according to an exemplary embodiment of the disclosure.

FIG. 10 is a schematic diagram of a microarray biochip manufactured according to the method of FIG. 9A and FIG. 9B.

FIG. 11 is a schematic diagram of a carrier according to another exemplary embodiment of the disclosure.

FIGS. 12A-12E are exploded views of the carrier of FIG. 11.

FIG. 13A and FIG. 13B are schematic diagrams illustrating a flow of manufacturing a microarray biochip according to an exemplary embodiment of the disclosure.

FIG. 14 is a schematic diagram of a carrier according to another exemplary embodiment of the disclosure.

FIG. 15A and FIG. 15B are schematic diagrams illustrating a flow of manufacturing a microarray biochip according to an exemplary embodiment of the disclosure.

FIG. 16 is a schematic diagram of a microarray biochip manufactured according to the method of FIG. 15A and FIG. 15B.

FIG. 17A and FIG. 17B are schematic diagrams illustrating a flow of manufacturing a microarray biochip according to an exemplary embodiment of the disclosure.

FIG. 18A is a schematic diagram of a carrier according to an exemplary embodiment of the disclosure.

FIG. 18B is an exploded view of the carrier of FIG. 18A.

FIG. 19 is a schematic diagram of a carrier according to another exemplary embodiment of the disclosure.

FIG. 20A and FIG. 20B are schematic diagrams illustrating a flow of manufacturing a microarray biochip according to an exemplary embodiment of the disclosure.

FIG. 21 is a schematic diagram of a microarray biochip manufactured according to the method of FIG. 20A and FIG. 20B.

FIG. 22 is a schematic diagram of a carrier according to another exemplary embodiment of the disclosure.

FIG. 23A is a schematic diagram of a carrier according to an exemplary embodiment of the disclosure.

FIG. 23B is an exploded view of the carrier of FIG. 23A.

FIG. 24A to FIG. 24B are schematic diagrams of a flow of manufacturing a microarray biochip according to an exemplary embodiment of the disclosure.

FIG. 25A is a schematic diagram of a carrier according to an exemplary embodiment of the disclosure.

FIG. 25B is an exploded view of the carrier of FIG. 25A.

FIG. 26 is an exploded view of a carrier according to an exemplary embodiment of the disclosure.

FIG. 27 is a schematic diagram of a flow of manufacturing a microarray biochip according to an exemplary embodiment of the disclosure.

FIG. 28 is an exploded view of a carrier according to an exemplary embodiment of the disclosure.

FIG. 29 is an exploded view of a carrier according to an exemplary embodiment of the disclosure.

### DETAILED DESCRIPTION

### First Exemplary Embodiment

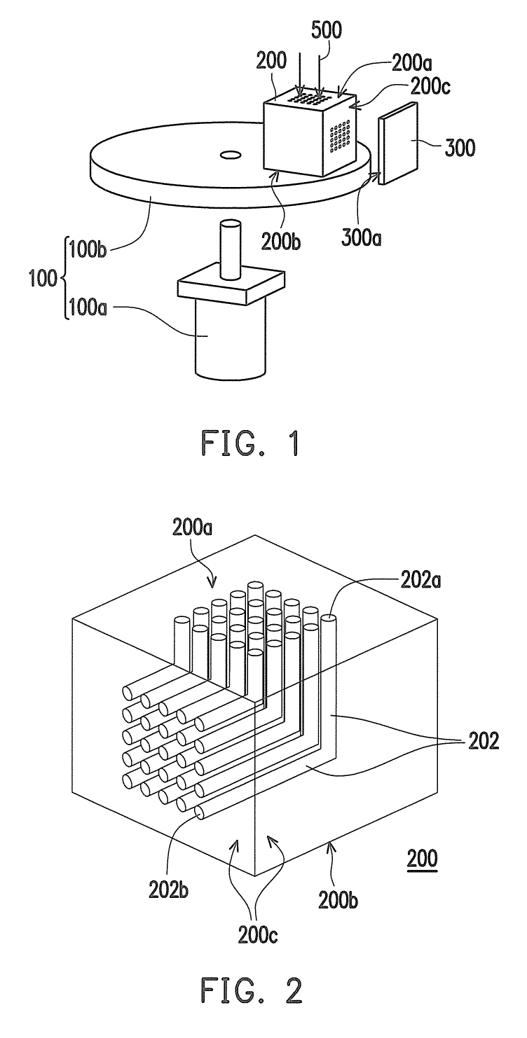

FIG. 1 is a schematic diagram of an apparatus of manufacturing a microarray biochip according to an exemplary embodiment of the disclosure. Referring to FIG. 1, the apparatus of manufacturing the microarray biochip of the present exemplary embodiment comprises a spinning platen 100, at least one carrier 200 and at least one substrate 300.

In the present embodiment, the spinning platen 100 comprises a rotation motor 100a and a rotation plate 100b installed on the rotation motor 100a. When the rotation motor 100a is powered on, the rotation motor 100a drives the rotation plate 100b to rotate clockwise or anticlockwise. Moreover, by adjusting a rotation speed of the rotation motor 100a, a rotation speed of the rotation plate 100b is adjusted.

The carrier 200 is fixed on the spinning platen 100. In detail, the carrier 200 is fixed on the rotation plate 100b of the spinning platen 100. In the present embodiment, the carrier 200 is a block carrier having an upper surface 200a, a lower surface 200b and a plurality of side surfaces 200c. The lower surface 200b of the carrier 200 faces to the rotation plate 100b, so that the lower surface 200b of the carrier 200 can be fixed to the rotation plate 100b.

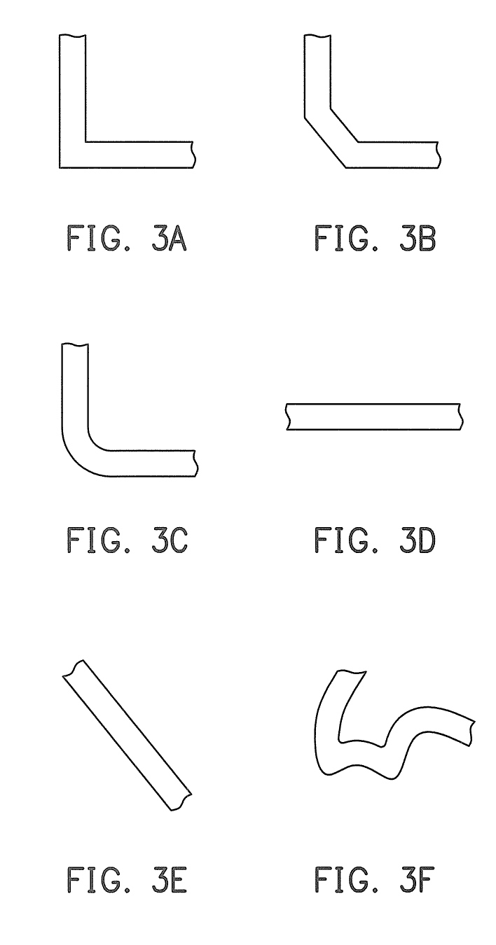

FIG. 2 is a diagram illustrating a structure of the carrier 200 of FIG. 1. As shown in FIG. 2, the carrier 200 comprises at least one micro-channel 202, and each of the micro-channels 202 has an input terminal 202a and an output terminal 202b. Therefore, the two terminals of the micro-channel 202 of the carrier 200 are all opened openings. If the carrier 200 comprises a plurality of the micro-channels 202, a plurality of samples can be simultaneously immobilized on a chip in a post processing process. In the present exemplary embodiment, the input terminals 202a of the micro-channels 202 are located on the upper surface 200a of the carrier 200, and the output terminals 202b of the micro-channels 202 are located on one of the side surfaces 200c of the carrier 200. Therefore, the micro-channel 202 of the present exemplary embodiment is an L-shape channel. However, the disclosure is not limited thereto, and in other embodiments, besides the L-shape channel shown in FIG. 3A, the micro-channel 202 of the carrier 200 can also be an L-shape channel comprising a plane chamfer as that shown in FIG. 3B, an L-shape channel comprising an arc chamfer as that shown in FIG. 3C, a straight line channel as that shown in FIG. 3D, an oblique line channel as that shown in FIG. 3E, or a curved line channel as that shown in FIG. 3F.

Referring to FIG. 1 and FIG. 2, the substrate 300 is attached to the output terminals 202b of the micro-channels 202 of the carrier 200. The substrate 300 can be directly attached to the carrier 200 or indirectly attached to the carrier 200. In the present exemplary embodiment, the substrate 300 is directly attached to the carrier 200, and the substrate 300 is closely fixed to the side surface 200c of the carrier 200, and the output terminals 202b of the micro-channels 202 of the carrier 200 contact a surface 300a of the substrate 300. The substrate 300 can be a glass substrate, a plastic substrate, a silicon substrate or other suitable substrates.

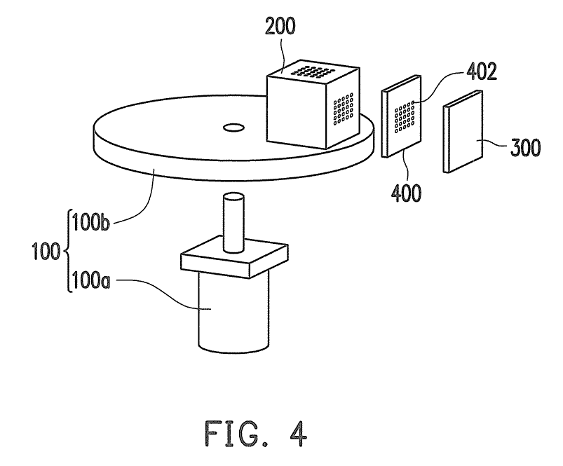

According to another exemplary embodiment of the disclosure, in the apparatus of manufacturing the microarray biochip, a pad 400 can be further disposed between the carrier 200 and the substrate 300, as that shown in FIG. 4, so that the substrate 300 is indirectly attached to the carrier 200. The pad 400 comprises at least one through via 402. The through vias 402 are connected to or communicated with the micro-channels 202 of the carrier 200, so that the output terminals 202b of the micro-channels 202 of the carrier 200 can still expose the surface 300a of the substrate 300. Here, the pad 400 is made of a flexible material, which may increase adaptation between the carrier 200 and the substrate 300 to prevent leakage of fluid in the micro-channels 202 of the carrier 200. It should be noticed that if the carrier 200 is made of a flexible material, the pad 400 can be omitted. If the carrier 200 is made of a hard material, the pad 400 can be disposed between the carrier 200 and the substrate 300.

A method of manufacturing a microarray biochip is described below with reference of the aforementioned apparatus. The apparatus of FIG. 1 is taken as an example for descriptions. Those skilled in the art can easily deduce the method of manufacturing the microarray biochip based on the apparatus of FIG. 4 according to the method described with reference of the apparatus of FIG. 1.

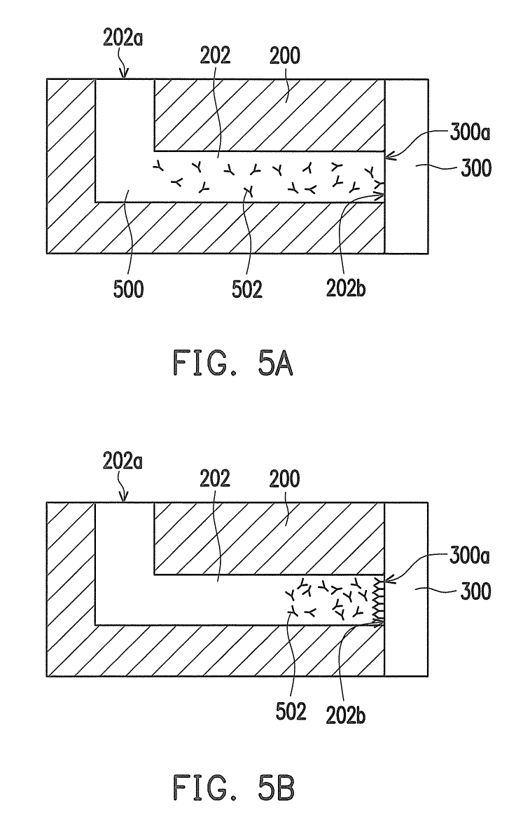

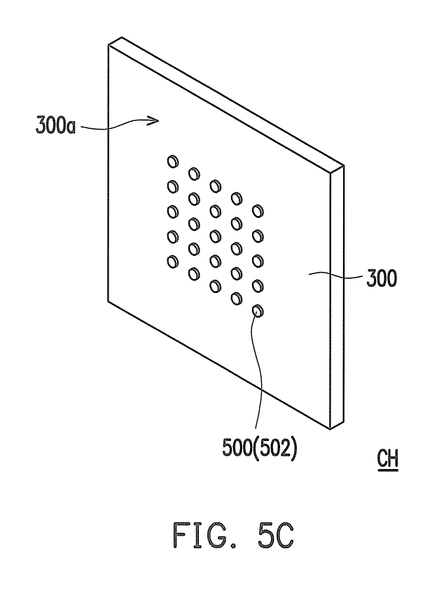

Referring to FIG. 1, the substrate 300 is attached to the carrier 200 to contact the output terminals 202b of the micro-channels 202 of the carrier 200 to the surface 300a of the substrate 300. In the present exemplary embodiment, the surface 300a of the substrate 300 is a treated surface, for example, the surface 300a of the substrate 300 is bonded with gold atoms or other metal atoms, or other functional groups capable of attracting or bonding with the biological molecules. Moreover, the surface 300a of the substrate 300 can be treated with a local dot surface treatment or a full surface treatment. Then, a sample 500 is injected into the micro-channel 202 of the carrier 200 through the input terminal 202a. Here, the sample 500 is a biological sample containing specific biological molecules or particles 502. Now, the sample 500 is automatically sucked into the micro-channel 202 based on capillarity. As shown in FIG. 5A, after the sample 500 is injected through the input terminal 202a of the micro-channel 202, the sample 500 is automatically sucked into the micro-channel 202 based on capillarity.

Then, the carrier 200 and the substrate 300 are fixed to the spinning platen 100. The spinning platen 100 is powered-on to provide a centrifugal force to the carrier 200, such that the sample 500 in the micro-channel 202 is flowed towards the output terminal 202b from the input terminal 202a of the micro-channel 202, and is immobilized on the surface 300a of the substrate 300. As shown in FIG. 5B, due to the centrifugal force, the biological molecules or particles 502 are moved and concentrated to the output terminals 202b, so that the biological molecules or particles 502 can be quickly and evenly immobilized on the surface 300a of the substrate 300. Since the surface 300a of the substrate 300 comprises the metal atoms or functional groups capable of attracting (bonding) with the biological molecules or particles 502, the biological molecules or particles 502 can be immobilized on the surface 300a of the substrate 300.

It should be noticed that in the step of powering on the spinning platen 100 to provide the centrifugal force to the carrier 200, a disturbance procedure is performed to the sample 500 in the micro-channel 202 of the carrier 200. The disturbance procedure comprises forward and backward rotations or accelerating and decelerating rotations of the spinning platen 100. During the rotating process of the spinning platen 100, the sample 500 in the micro-channel 202 is functioned by a Coriolis force, an Euler force and the centrifugal force. Therefore, when a rotation parameter of the spinning platen 100 is changed (for example, forward and backward rotations or accelerating and decelerating rotations), the sample 500 located at different positions of the micro-channel 202 is function by different degrees of the Coriolis force, the Euler force and the centrifugal force, so as to achieve a disturbance effect on the sample 500 in the micro-channel 202. In this way, the biological molecules or particles 502 that are not successfully immobilized on the surface 300a of the substrate 300 are taken away from the surface 300a of the substrate 300, and other biological molecules or particles 502 in the sample 500 may have more opportunities to contact the surface 300a of the substrate 300.

After the above step is completed, the substrate 300 is taken away from the carrier 200 to obtain a chip CH shown in FIG. 5C. The chip CH comprises the substrate 300 and a plurality of regions containing the biological molecules or particles 502 on the surface 300a of the substrate 300. The regions containing the biological molecules or particles 502 on the surface 300a of the substrate 300 can immobilize different biological molecules or particles or the same biological molecules or particles, which are determined according to an actual application of the microarray biochip.

In the aforementioned exemplary embodiment, the sample 500 containing the specific biological molecules or particles 502 is taken as an example, and the surface 300a of the substrate 300 treated with the surface treatment is taken as an example for description, though the disclosure is not limited thereto, and in another exemplary embodiment, the sample 500 can also be a surface treatment reagent for treating the substrate 300, which is used to perform surface treatment to local areas of the substrate 300. In other words, when the sample 500 containing the surface treatment reagent is injected into the carrier 200, and the spinning platen 100 is powered on, due to the function of the centrifugal force, the sample 500 containing the surface treatment reagent can be immobilized on or reacted with the surface 300a of the substrate 300, so that the surface 300a of the substrate 300 comprises the surface treatment reagent (for example, gold atoms or other metal atoms, or other functional groups capable of attracting or bonding with the biological molecules). Then, a biological sample 500 containing the specific biological molecules or particles 502 can be injected into the carrier 200, and after the spinning platen 100 is powered on, due to the function of the centrifugal force, the biological sample 500 containing the specific biological molecules or particles 502 is immobilized on the treated surface 300a of the substrate 300.

Moreover, in the present exemplary embodiment, the sample 500 is injected through the input terminal 202a of the micro-channel 202 of the carrier 200. However, in other embodiments, the sample 500 can also be injected through the output terminal 202b of the micro-channel 202 of the carrier 200. Then, the sample 500 is automatically sucked into the micro-channel 202 based on capillarity. Injection of the sample 500 from the output terminal 202b of the micro-channel 202 of the carrier 200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

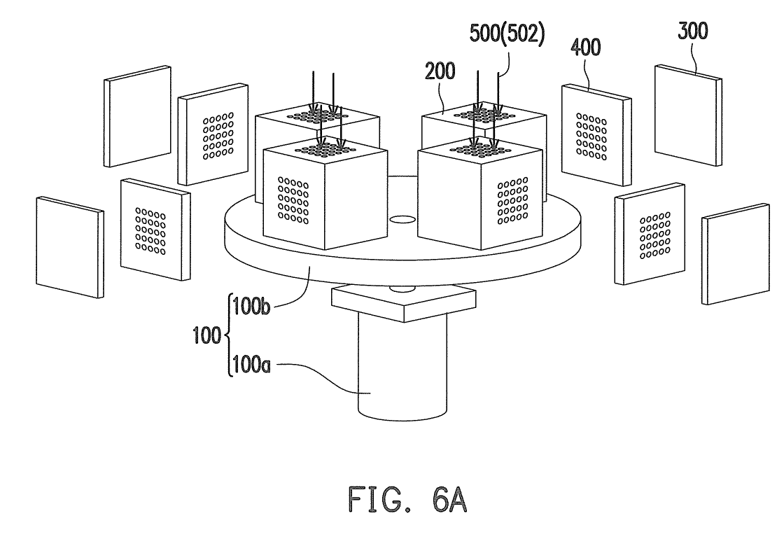

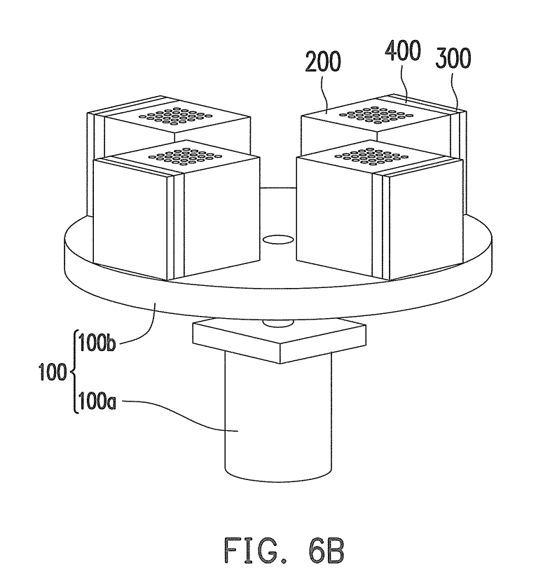

FIG. 6A and FIG. 6B are schematic diagrams illustrating a flow of manufacturing a microarray biochip according to an exemplary embodiment of the disclosure. Referring to FIG. 6A, the apparatus of manufacturing the microarray biochip of the present exemplary embodiment is similar to that of the exemplary embodiments of FIG. 1 and FIG. 4, and the same devices of FIG. 6A, FIG. 1 and FIG. 4 are represented by the same symbols, and detailed descriptions thereof are not repeated. A difference between the exemplary embodiment of FIG. 6A and the exemplary embodiments of FIG. 1 and FIG. 4 is that a plurality of carriers 200 is disposed on the spinning platen 100, and each carrier 200 is configured with a corresponding substrate 300. If the pad 400 is about to be disposed between the carrier 200 and the substrate 300, the pad 400 is disposed between each of the carriers 200 and the corresponding substrate 300.

Referring to FIG. 6B, after the substrates 300 are respectively attached to the carriers 200, the sample 500 is injected through the input terminals 202a of the micro-channels 202 of the carrier 200. Now, the sample 500 is automatically sucked into the micro-channels 202 based on capillarity. Then, the spinning platen 100 is powered on to provide the centrifugal force to the carriers 200, such that the sample 500 in the micro-channels 202 is flowed towards the output terminals 202b from the input terminals 202a of the micro-channels 202, and the specific biological molecules or particles 502 in the sample 500 is immobilized on the surfaces 300a of the substrates 300.

In the present exemplary embodiment, since a plurality of the =Tiers 200 and a plurality of the substrates 300 are disposed on the spinning platen 100, when a rotation procedure is performed, fabrication of a plurality of microarray biochips CH can be simultaneously completed.

It should be noticed that in the exemplary embodiments of FIG. 4, FIG. 6A and FIG. 6B, although the pad 400 is disposed between the carrier 200 and the substrate 300, in other embodiments, configuration of the pad 400 can be omitted. Moreover, in the exemplary embodiments of FIG. 4, FIG. 6A and FIG. 6B, besides the L-shape channel, the micro-channel 202 of each of the carriers 200 can also be an L-shape channel comprising a plane chamfer as that shown in FIG. 3B, an L-shape channel comprising an arc chamfer as that shown in FIG. 3C, a straight line channel as that shown in FIG. 3D, an oblique line channel as that shown in FIG. 3E, or a curved line channel as that shown in FIG. 3F. Moreover, in the present exemplary embodiment, the sample 500 is injected through the input terminal 202a of the micro-channel 202 of the carrier 200. However, in other embodiments, the sample 500 can also be injected through the output terminal 202b of the micro-channel 202 of the carrier 200. Then, the sample 500 is automatically sucked into the micro-channel 202 based on capillarity. Injection of the sample 500 from the output terminal 202b of the micro-channel 202 of the carrier 200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

### Second Exemplary Embodiment

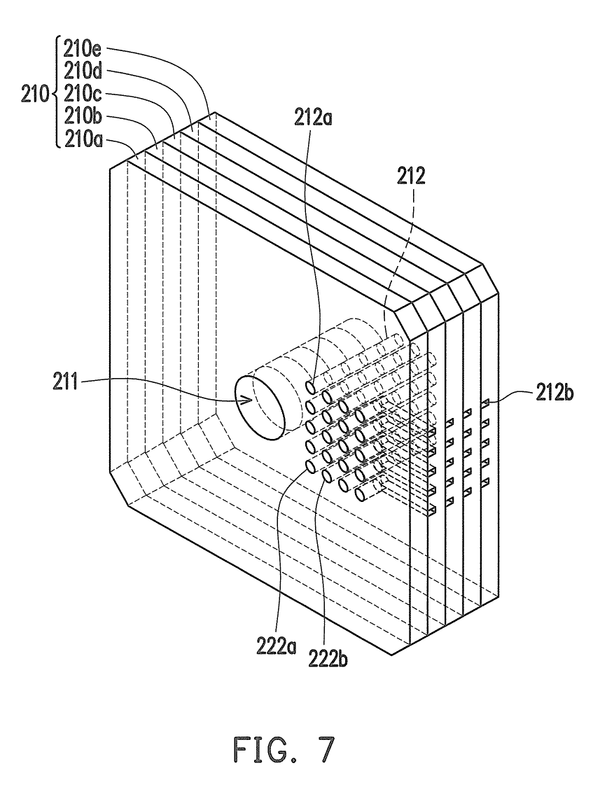

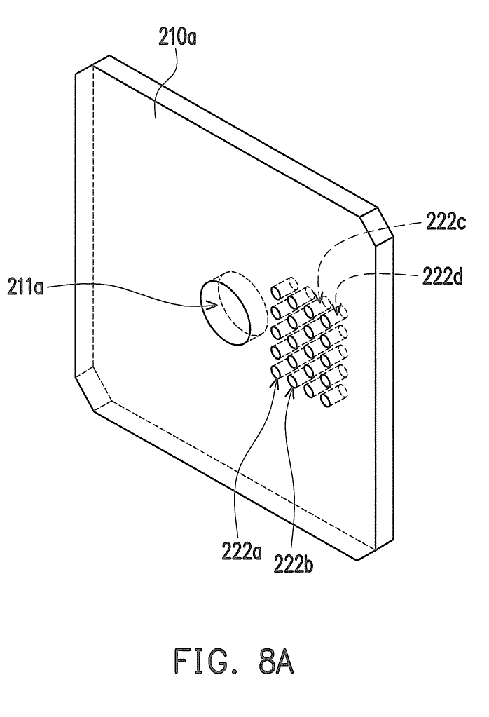

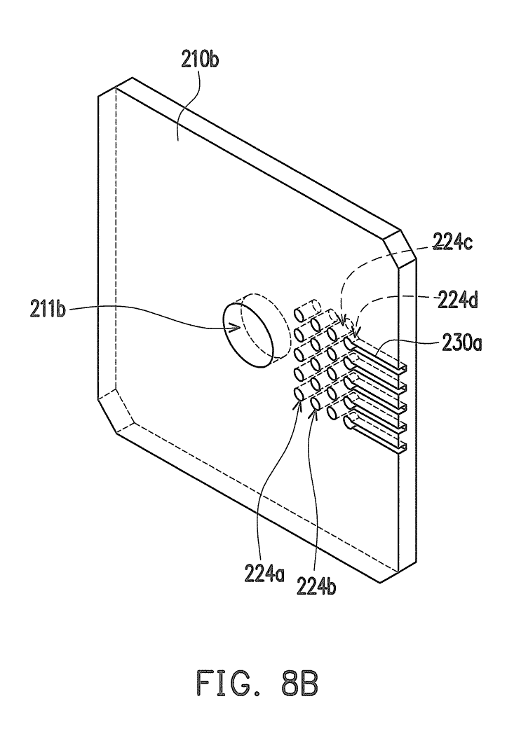

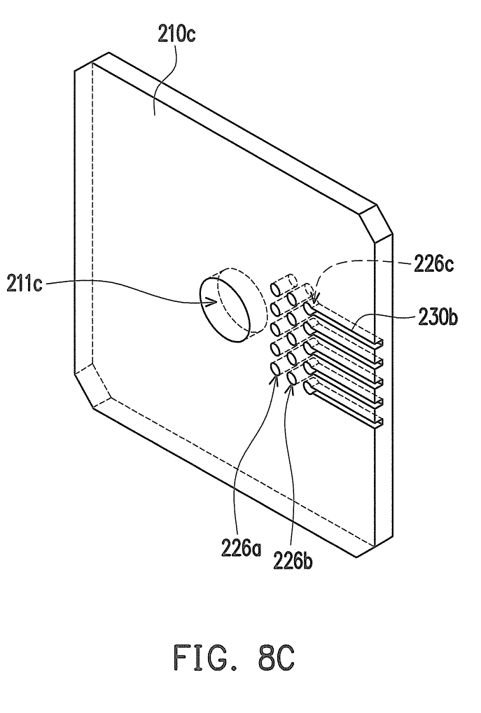

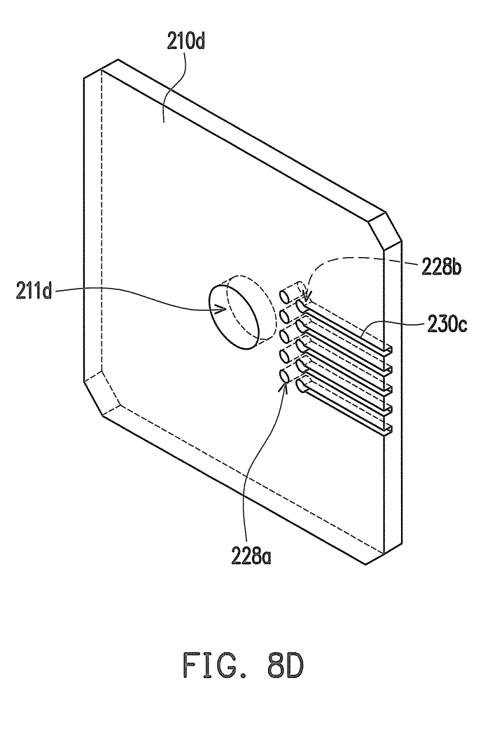

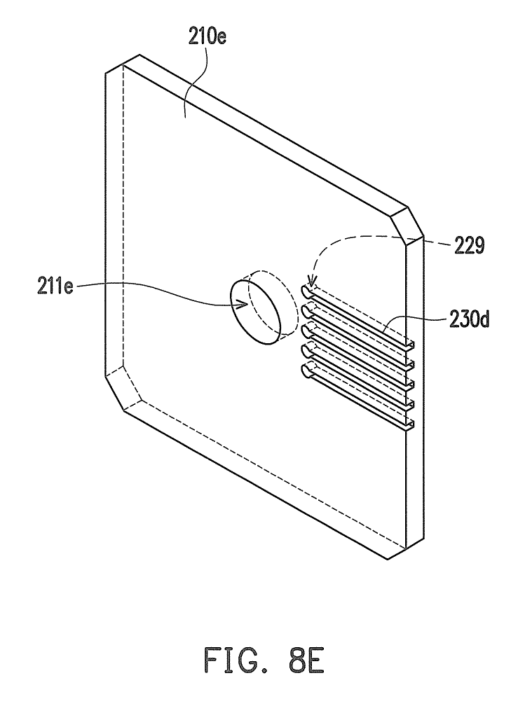

FIG. 7 is a schematic diagram of a carrier according to another exemplary embodiment of the disclosure. FIGS. 8A-8E are exploded views of the carrier of FIG. 7. Referring to FIG. 7 and FIGS. 8A-8E, in the apparatus of manufacturing the microarray biochip, the carrier 210 is formed by stacking a top disc 210a (shown in FIG. 8A) and at least one channel discs 210b-210e (shown in FIGS. 8B-8E). The carrier 210 comprises a rotation shaft hole 211 and at least one micro-channel 212, where each of the micro-channels 212 comprises an input terminal 212a and an output terminal 212b. In other words, each of the micro-channel 212 of the carrier 210 is composed of the voids and the channels in the top disc 210a and the channel disc 210b-210e.

In the present exemplary embodiment, the carrier 210 formed by stacking the top disc 210a, the first channel disc 210b, the second channel disc 210c, the third channel disc 210d and the fourth channel disc 210e is taken as an example for description. However, the number of the channel discs is not limited by the disclosure, which can be less than four or more than four.

In detail, the top disc 210a of FIG. 8A comprises a rotation shaft hole 211a and a plurality rows of infection holes 222a-222d. The first channel disc 210b of FIG. 8B comprises a rotation shaft hole 211b, injection openings 224a-224d and flowing channels 230a, where the flowing channels 230a are connected to the injection openings 224d. The second channel disc 210c of FIG. 8C comprises a rotation shaft hole 211c, injection openings 226a-226c and flowing channels 230b, where the flowing channels 230b are connected to the injection openings 226c. The third channel disc 210d of FIG. 8D comprises a rotation shaft hole 211d, injection openings 228a-228b and flowing channels 230c, where the flowing channels 230c are connected to the injection openings 228b. The fourth channel disc 210e of FIG. 8E comprises a rotation shaft hole 211e, injection openings 229 and flowing channels 230d, where the flowing channels 230d are connected to the injection openings 229.

Positions of the first row of the injection holes 222a of the top disc 210a of FIG. 8A correspond to positions of the injection openings 224a of the first channel disc 210b of FIG. 8B, correspond to positions of the injection openings 226a of the second channel disc 210c of FIG. 8C, correspond to positions of the injection openings 228a of the third channel disc 210d of FIG. 8D, and correspond to positions of the injection openings 229 of the fourth channel disc 210e of FIG. 8E.

Positions of the second row of the injection holes 222b of the top disc 210a of FIG. 8A correspond to positions of the injection openings 224b of the first channel disc 210b of FIG. 8B, correspond to positions of the injection openings 226b of the second channel disc 210c of FIG. 8C, and correspond to positions of the injection openings 228b of the third channel disc 210d of FIG. 8D.

Positions of the third row of the injection holes 222c of the top disc 210a of FIG. 8A correspond to positions of the injection openings 224c of the first channel disc 210b of FIG. 8B, and correspond to positions of the injection openings 226c of the second channel disc 210c of FIG. 8C.

Positions of the fourth row of the injection holes 222d of the top disc 210a of FIG. 8A correspond to positions of the injection openings 224d of the first channel disc 210b of FIG. 8B.

Therefore, after stacking the top disc 210a, the first channel disc 210b, the second channel disc 210c, the third channel disc 210d and the fourth channel disc 210e, the voids and the flowing channels in the top disc 210a and the channel discs 210b-210e can be combined to form the micro-channels 212 of the carrier 210. The rotation shaft holes 211a-211e in the top disc 210a and the channel discs 210b-210e are combined to form the rotation shaft hole 211 of the carrier 210.

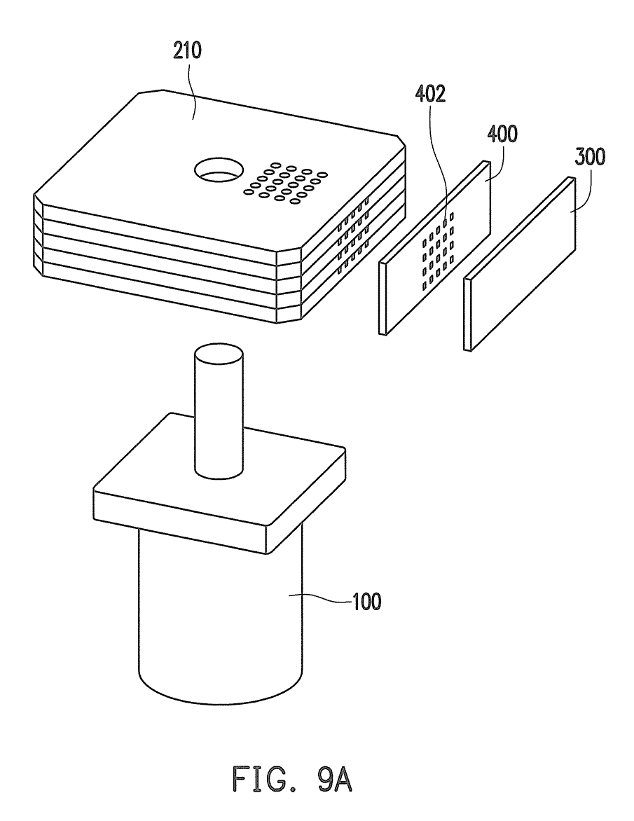

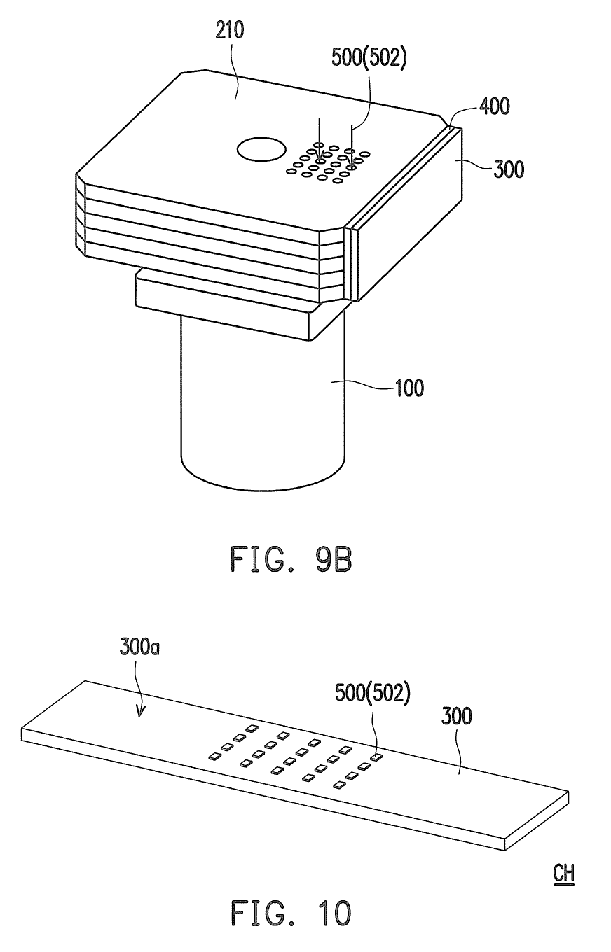

A method of manufacturing the microarray biochip is described below with reference of the aforementioned apparatus. Referring to FIG. 9A and FIG. 9B, the carrier 210 is installed on the spinning platen 100 through the rotation shaft hole 211. After the substrate 300 is attached to the carrier 210 (the pad 400 can be selectively disposed between the substrate 300 and the carrier 210), the sample 500 is injected through the input terminals 212a of the micro-channels 212 of the carrier 210. Now, the sample 500 is automatically sucked into the micro-channels 202 based on capillarity. Then, the spinning platen 100 is powered-on to provide a centrifugal force to the carrier 210, such that the sample 500 in the micro-channel 212 is flowed towards the output terminal 212b from the input terminal 212a of the micro-channel 212, and the biological molecules or particles 502 in the sample 500 are immobilized on the surface 300a of the substrate 300.

After the above step is completed, the substrate 300 is taken away from the carrier 210 to obtain a chip CH shown in FIG. 10. The chip CH comprises the substrate 300 and a plurality of regions containing the biological molecules or particles 502 on the surface 300a of the substrate 300. The regions containing the biological molecules or particles 502 on the surface 300a of the substrate 300 can immobilize different biological molecules or particles or the same biological molecules or particles, which are determined according to an actual application of the microarray biochip.

It should be noticed that in the exemplary embodiments of FIG. 7, FIGS. 8A-8E and FIGS. 9A-9B, although the pad 400 is disposed between the carrier 210 and the substrate 300, in other embodiments, configuration of the pad 400 can be omitted. Moreover, in the exemplary embodiments of FIG. 7, FIGS. 8A-8E and FIGS. 9A-9B, besides the L-shape channel shown in FIG. 7, the micro-channel 212 of the carrier 210 can also be an L-shape channel comprising a plane chamfer as that shown in FIG. 3B, an L-shape channel comprising an arc chamfer as that shown in FIG. 3C, a straight line channel as that shown in FIG. 3D, an oblique line channel as that shown in FIG. 3E, or a curved line channel as that shown in FIG. 3F. Moreover, in other embodiments, the sample 500 can also be injected through the output terminal 212b of the micro-channel 212 of the carrier 210. Then, the sample 500 is automatically sucked into the micro-channel 212 based on capillarity. Injection of the sample 500 from the output terminal 212b of the micro-channel 212 of the carrier 210 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

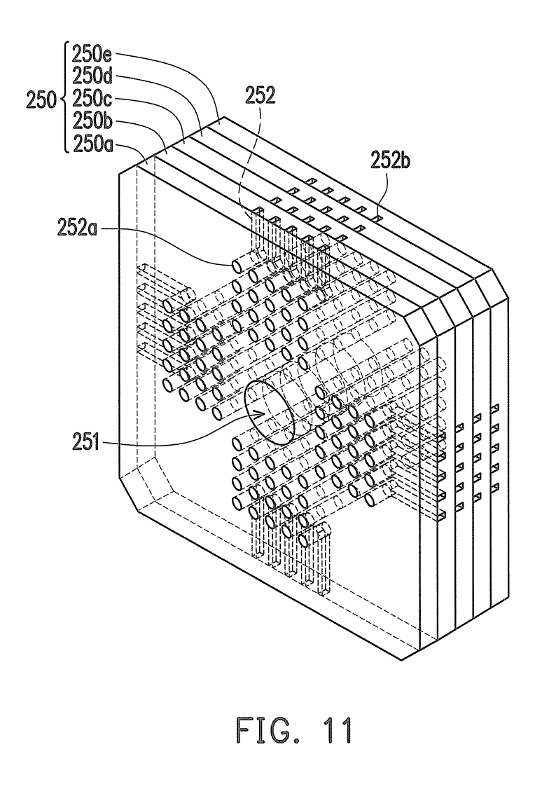

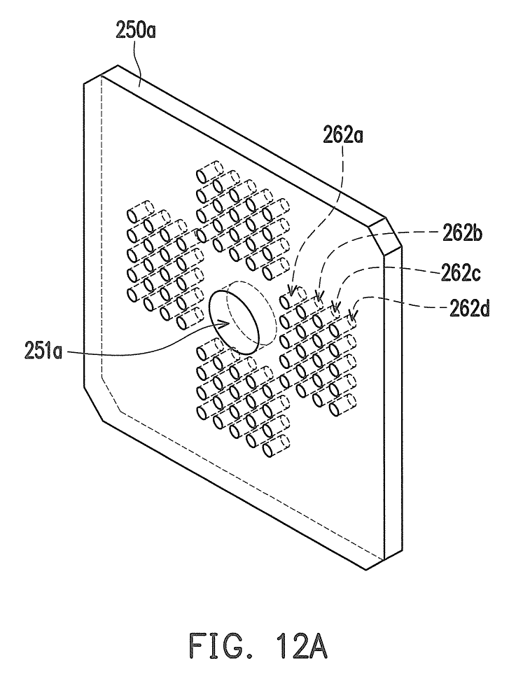

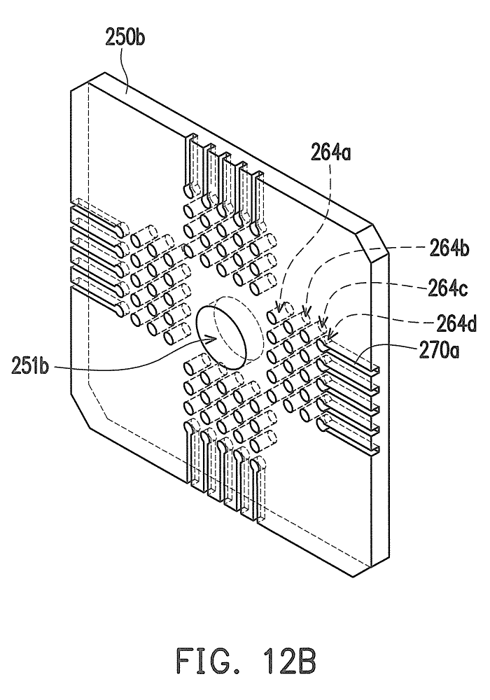

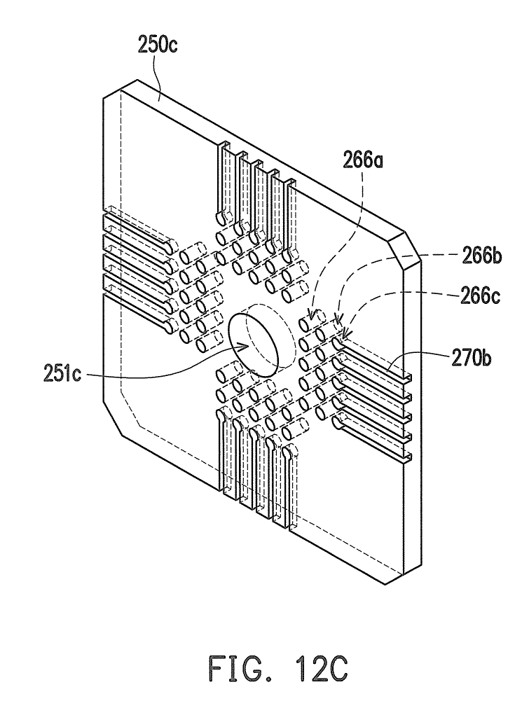

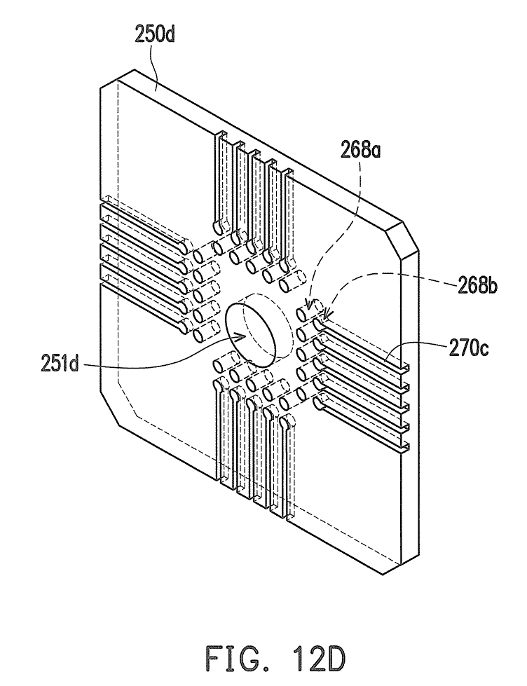

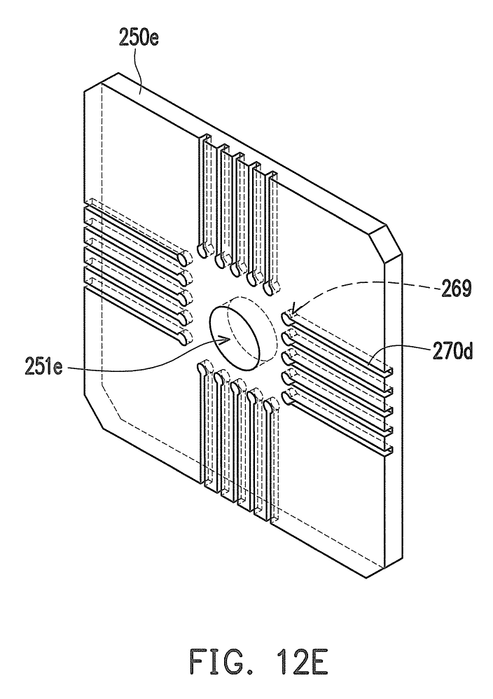

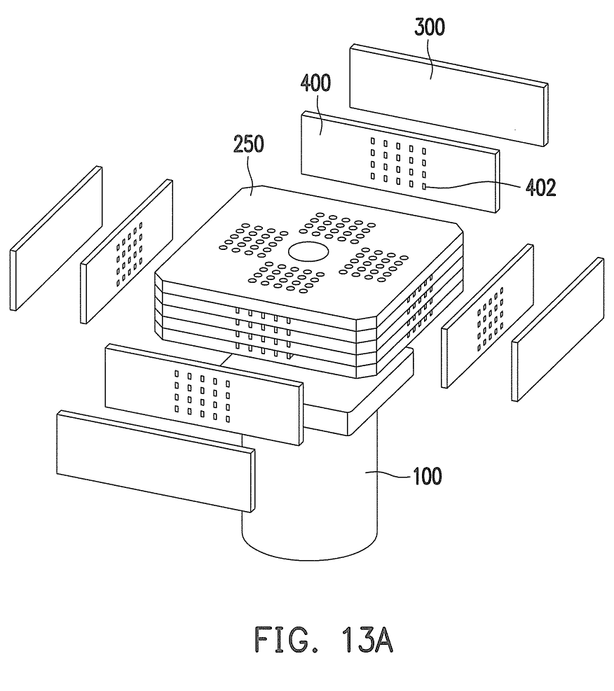

FIG. 11 is a schematic diagram of a carrier according to another exemplary embodiment of the disclosure. FIGS. 12A-12E are exploded views of the carrier of FIG. 11. A difference between the carrier of FIG. 11 and the carrier of FIG. 7 is that more micro-channels 252 are designed in the carrier 250 of FIG. 11. Similarly, each micro-channel 252 of the carrier 250 comprises an input terminal 252a and an output terminal 252b. The carrier 250 of FIG. 11 also comprises a rotation shaft hole 251.

In the present exemplary embodiment, the carrier 250 is formed by stacking a top disc 250a, a first channel disc 250b, a second channel disc 250c, a third channel disc 250d and a fourth channel disc 250e. The top disc 250a of FIG. 12A comprises a rotation shaft hole 251a and a plurality rows of infection holes 262a-262d. The first channel disc 250b of FIG. 12B comprises a rotation shaft hole 251b, injection openings 264a-264d and flowing channels 270a, where the flowing channels 270a are connected to the injection openings 264d. The second channel disc 250c of FIG. 12C comprises a rotation shaft hole 251c, injection openings 266a-266c and flowing channels 270b, where the flowing channels 270b are connected to the injection openings 266c. The third channel disc 250d of FIG. 12D comprises a rotation shaft hole 251d, injection openings 268a-268b and flowing channels 270c, where the flowing channels 270c are connected to the injection openings 268b. The fourth channel disc 250e of FIG. 12E comprises a rotation shaft hole 251e, injection openings 269 and flowing channels 270d, where the flowing channels 270d are connected to the injection openings 269.

As described above, after stacking the top disc 250a, the first channel disc 250b, the second channel disc 250c, the third channel disc 250d and the fourth channel disc 250e, the injection openings and the flowing channels in the top disc 250a and the channel discs 250b-250e can be combined to form the micro-channels 252 of the carrier 250. The rotation shaft holes 251a-251e in the top disc 250a and the channel discs 250b-250e are combined to form the rotation shaft hole 251 of the carrier 250.

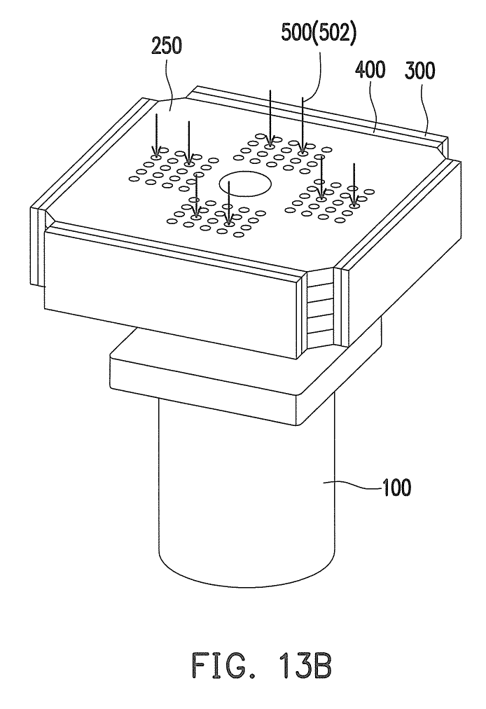

A method of manufacturing the microarray biochip is described below with reference of the aforementioned apparatus. Referring to FIG. 13A and FIG. 13B, the carrier 250 is installed on the spinning platen 100 through the rotation shaft hole 251. After the substrates 300 are attached to the carrier 250 (the pads 400 can be selectively disposed between the substrates 300 and the carrier 250), the sample 500 is injected through the input terminals 252a of the micro-channels 252 of the carrier 250. Now, the sample 500 is automatically sucked into the micro-channels 252 based on capillarity. Then, the spinning platen 100 is powered-on to provide a centrifugal force to the carrier 250, such that the sample 500 in the micro-channels 252 is flowed towards the output terminals 252b from the input terminals 252a of the micro-channels 252, and the biological molecules or particles 502 in the sample 500 are immobilized on the surfaces 300a of the substrates 300.

After the above step is completed, the substrates 300 are taken away from the carrier 250 to obtain chips CH shown in FIG. 10. The chip CH comprises the substrate 300 and a plurality of regions containing the biological molecules or particles 502 on the surface 300a of the substrate 300. The regions containing the biological molecules or particles 502 on the surface 300a of the substrate 300 can immobilize different biological molecules or particles or the same biological molecules or particles, which are determined according to an actual application of the microarray biochip.

Similarly, in the exemplary embodiments of FIG. 11, FIGS. 12A-12E and FIGS. 13A-13B, although the pad 400 is disposed between the carrier 250 and the substrate 300, in other embodiments, configuration of the pad 400 can be omitted. Moreover, in the exemplary embodiments of FIG. 11, FIGS. 12A-12E and FIGS. 13A-13B, besides the L-shape channel as that shown in FIG. 3A, the micro-channel 252 of the carrier 250 can also be an L-shape channel comprising a plane chamfer as that shown in FIG. 3B, an L-shape channel comprising an arc chamfer as that shown in FIG. 3C, a straight line channel as that shown in FIG. 3D, an oblique line channel as that shown in FIG. 3E, or a curved line channel as that shown in FIG. 3F. Moreover, in other embodiments, the sample 500 can also be injected through the output terminal 252b of the micro-channel 252 of the carrier 250. Then, the sample 500 is automatically sucked into the micro-channel 252 based on capillarity. Injection of the sample 500 from the output terminal 252b of the micro-channel 252 of the carrier 250 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

### Third Exemplary Embodiment

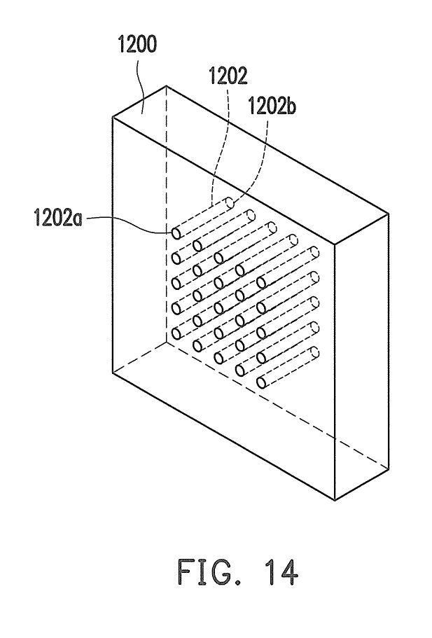

FIG. 14 is a schematic diagram of a carrier according to another exemplary embodiment of the disclosure. Referring to FIG. 14, the carrier 1200 of the present exemplary embodiment is a plate-type carrier, and the plate-type carrier 1200 comprises at least one micro-channel 1202 in form of a straight through via. Similarly, the micro-channel 1202 of the carrier 1200 comprises an input terminal 1202a and an output terminal 1202b. In the present exemplary embodiment, the micro-channel 1202 is a straight line channel, though the disclosure is not limited thereto. In other words, in other embodiments, the micro-channel 1202 of the plate-type carrier 1200 can also be an L-shape channel as that shown in FIG. 3A, an L-shape channel comprising a plane chamfer as that shown in FIG. 3B, an L-shape channel comprising an arc chamfer as that shown in FIG. 3C, an oblique line channel as that shown in FIG. 3E, or a curved line channel as that shown in FIG. 3F.

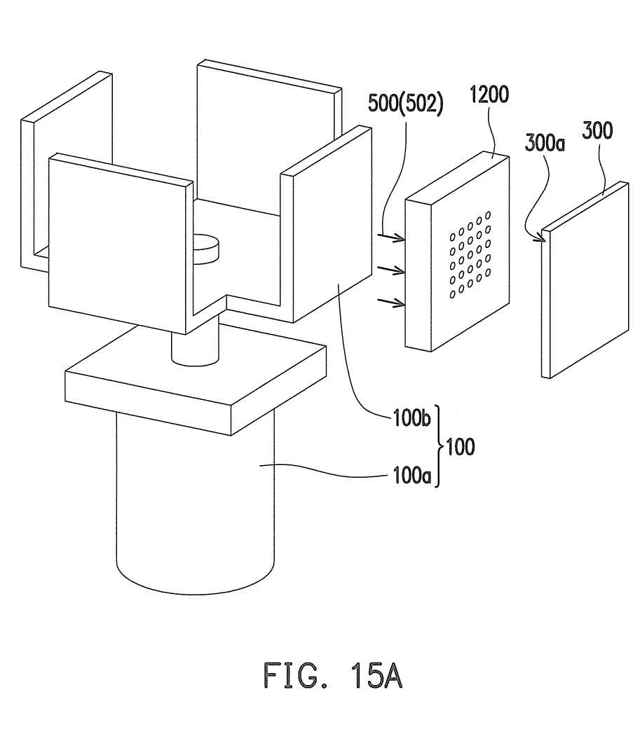

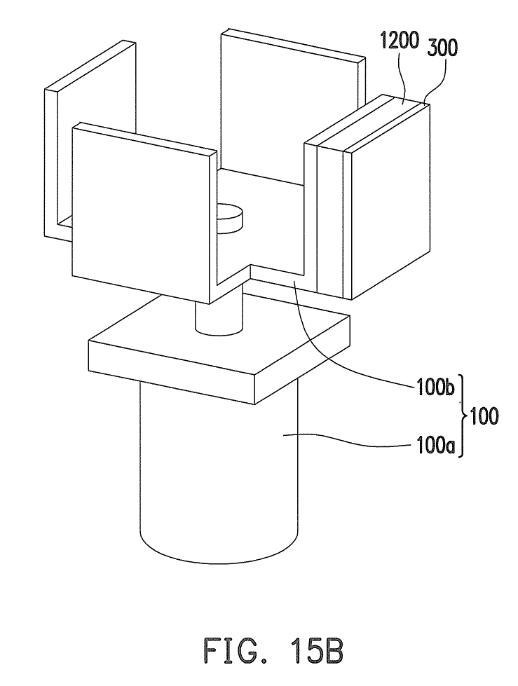

A method of manufacturing the microarray biochip is described below with reference of the aforementioned apparatus. Referring to FIG. 15A, a spinning platen 100 comprising the rotation motor 100a and the rotation plate 100b is first provided. Here, in collaboration with the plate-type carrier 1200, a structure of the rotation plate 100b is specially designed. Namely, the rotation plate 100b is designed to have a plurality of vertical fixing plates. The plate-type carrier 1200 can be fixed on the rotation plate 100b (the vertical fixing plates) of the spinning platen 100. Then, the sample 500 is injected through the input terminal 1202a of the micro-channel 1202 of the carrier 1200, and the sample 500 is automatically sucked into the micro-channel 1202 based on capillarity.

Referring to FIG. 15B, the substrate 300 is attached to the carrier 1200. Then, the spinning platen 100 is powered-on to provide a centrifugal force to the carrier 1200, such that the sample 500 in the micro-channel 1202 is flowed towards the output terminal 1202b from the input terminal 1202a of the micro-channel 1202, and the biological molecules or particles 502 in the sample 500 are immobilized on the surface 300a of the substrate 300.

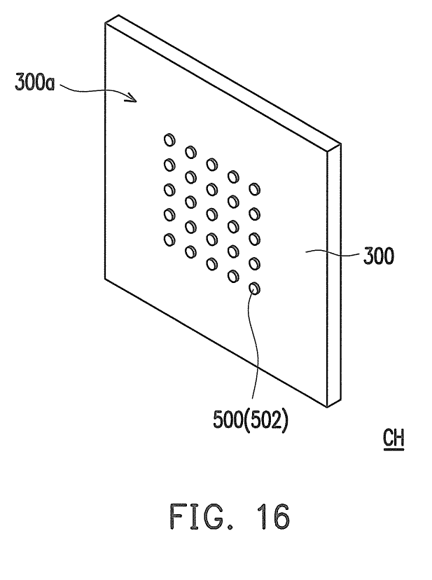

After the above step is completed, the substrate 300 is taken away from the carrier 1200 to obtain a chip CH shown in FIG. 16. The chip CH comprises the substrate 300 and a plurality of regions containing the biological molecules or particles 502 on the surface 300a of the substrate 300. The regions containing the biological molecules or particles 502 on the surface 300a of the substrate 300 can immobilize different biological molecules or particles or the same biological molecules or particles, which are determined according to an actual application of the microarray biochip.

In the exemplary embodiments of FIG. 14, FIGS. 15A-15B, although the carrier 1200 and the substrate 300 are directly attached, in other embodiments, a pad can be disposed between the carrier 1200 and the substrate 300. Moreover, in other embodiments, the sample 500 can also be injected through the output terminal 1202b of the micro-channel 1202 of the carrier 1200. Then, the sample 500 is automatically sucked into the micro-channel 1202 based on capillarity. Injection of the sample 500 from the output terminal 1202b of the micro-channel 1202 of the carrier 1200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

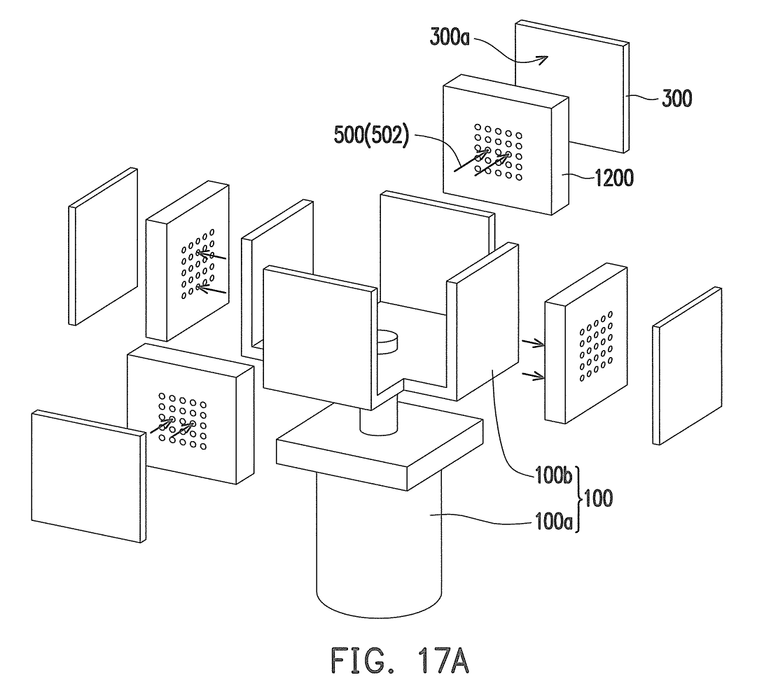

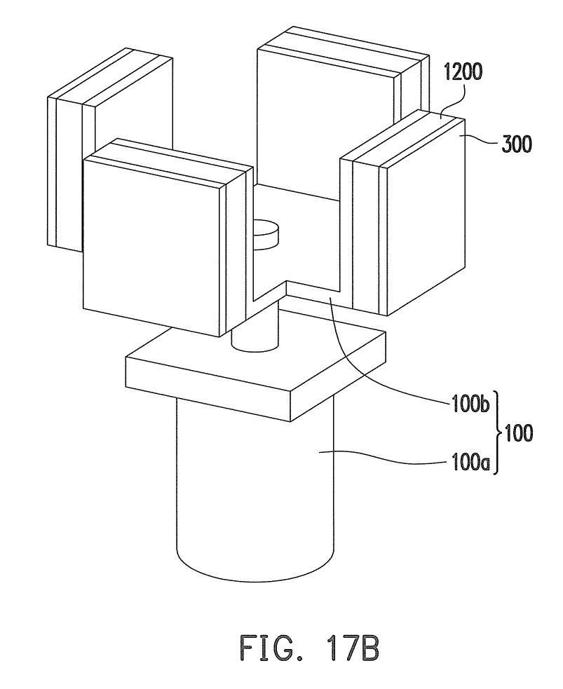

FIG. 17A and FIG. 17B are schematic diagrams illustrating a flow of manufacturing a microarray biochip according to an exemplary embodiment of the disclosure. Referring to FIG. 17A, the apparatus of manufacturing the microarray biochip of the present exemplary embodiment is similar to that of the exemplary embodiments of FIG. 15A, and the same devices in FIG. 17A and FIG. 15A are represented by the same symbols, and detailed descriptions thereof are not repeated. A difference between the embodiment of FIG. 17A and the embodiment of FIG. 15A is that a plurality of carriers 1200 is placed on the rotation plate 100b (the vertical fixing plates) of the spinning platen 100. Similarly, after the sample 500 is injected through the input terminal 1202a of the micro-channel 1202 of the carrier 1200, the sample 500 is automatically sucked into the micro-channel 1202 based on capillarity.

Referring to FIG. 17B, the corresponding substrate 300 is attached to each of the carriers 1200. Certainly, a pad (not shown) can be selectively disposed between the carrier 1200 and the substrate 300. Then, the spinning platen 100 is powered-on to provide a centrifugal force to the carrier 1200, such that the sample 500 in the micro-channels 1202 is flowed towards the output terminals 1202b from the input terminals 1202a of the micro-channels 1202, and the biological molecules or particles 502 in the sample 500 are immobilized on the surfaces 300a of the substrates 300.

Since a plurality of carriers 1200 and a plurality of substrates 300 are disposed on the spinning platen 100, when a rotation procedure is performed, fabrication of a plurality of microarray biochips CH can be simultaneously completed.

In the exemplary embodiment of FIG. 17A and FIG. 17B, although each of the carriers 1200 and the corresponding substrate 300 are directly attached. In other embodiments, a pad can be disposed between each of the carriers 1200 and the corresponding substrate 300.

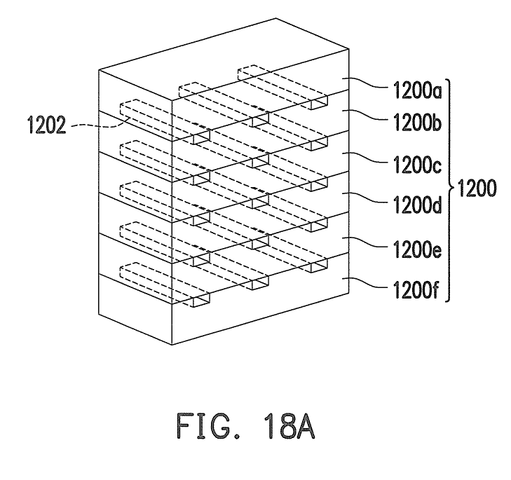

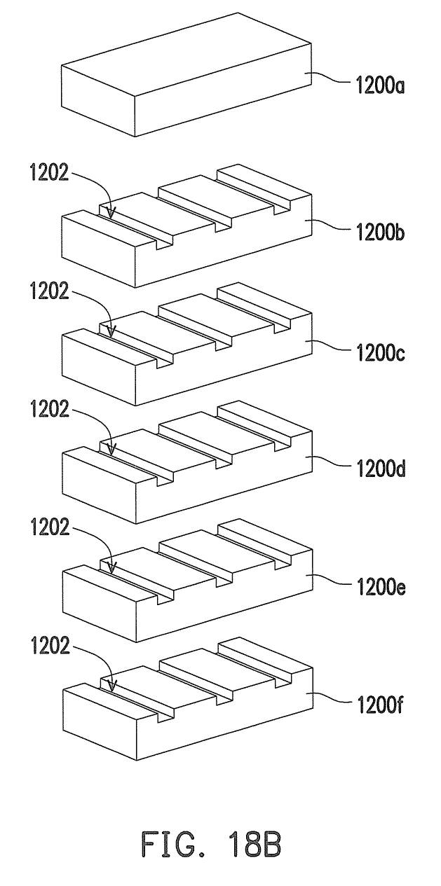

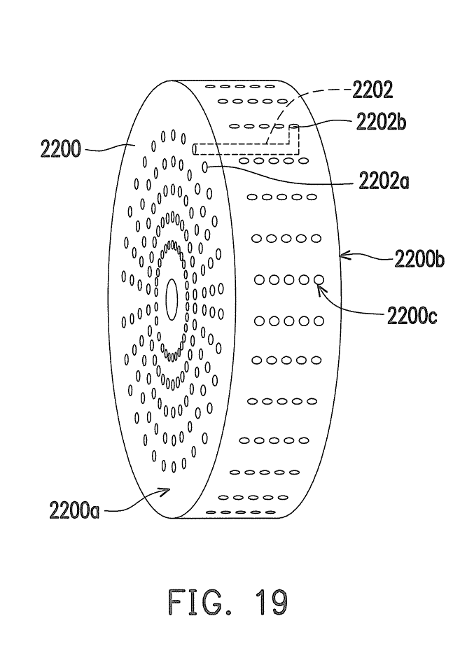

FIG. 18A is a schematic diagram of a carrier according to an exemplary embodiment of the disclosure. FIG. 18B is an exploded view of the carrier of FIG. 18A. Referring to FIG. 18A and FIG. 18B, the plate-type carrier 1200 of the present embodiment is formed by stacking a top disc 1200a and at least one channel discs 1200b-1200f, and each of the channel discs 1200b-1200f comprises at least one micro-channel 1202. In the present exemplary embodiment, the top disc 1200a does not have the micro-channel. After the top disc 1200a is stacked to the channel discs 1200b-1200f, the micro-channels 1202 penetrating through the carrier 1200 are formed.

In the above exemplary embodiments, the micro-channel 1202 of the carrier 1200 is a straight line channel, though the disclosure is not limited thereto. In other words, in other embodiments, the micro-channel 1202 of the plate-type carrier 1200 can also be an L-shape channel as that shown in FIG. 3A, an L-shape channel comprising a plane chamfer as that shown in FIG. 3B, an L-shape channel comprising an arc chamfer as that shown in FIG. 3C, an oblique line channel as that shown in FIG. 3E, or a curved line channel as that shown in FIG. 3F. Moreover, in other embodiments, the sample 500 can also be injected through the output terminal 1202b of the micro-channel 1202 of the carrier 1200. Then, the sample 500 is automatically sucked into the micro-channel 1202 based on capillarity. Injection of the sample 500 from the output terminal 1202b of the micro-channel 1202 of the carrier 1200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

### Fourth Exemplary Embodiment

FIG. 19 is a schematic diagram of a carrier according to another exemplary embodiment of the disclosure. Referring to FIG. 19, the carrier 2200 of the present exemplary embodiment is a round plate carrier, and comprises an upper surface 2200a, a lower surface 2200b and a ring-shape side surface 2200c. Moreover, the carrier 2200 also comprises at least one micro-channel 2202. Similarly, the micro-channel 2202 of the carrier 2200 comprises an input terminal 2202a and an output terminal 2202b, and the input terminal 2202a of the micro-channel 2202 is located on the upper surface 2200a of the carrier 2200, and the output terminal 2202b of the micro-channel 2202 is located on the ring-shape side surface 2200c of the carrier 2200.

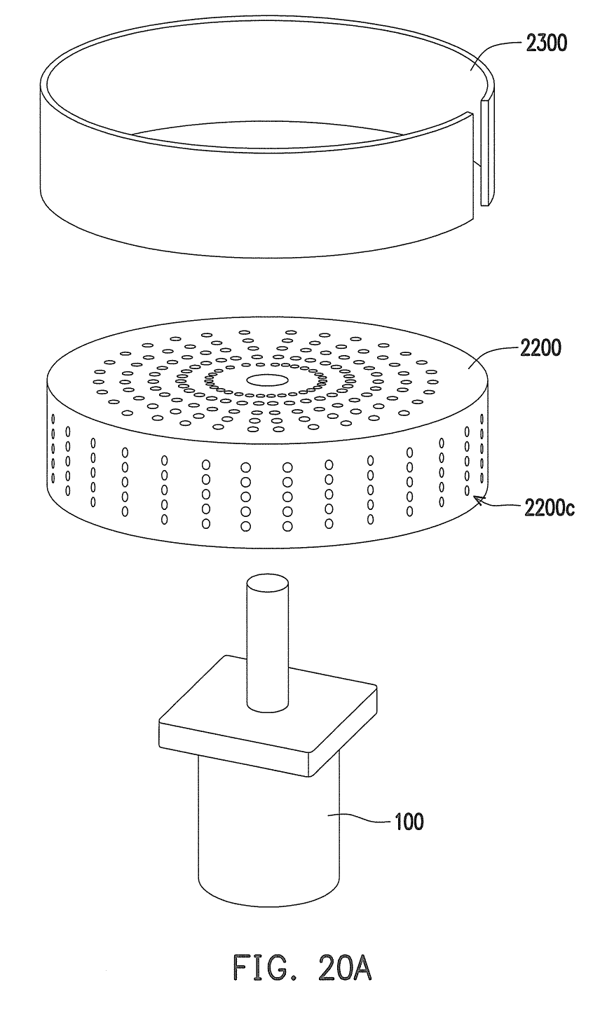

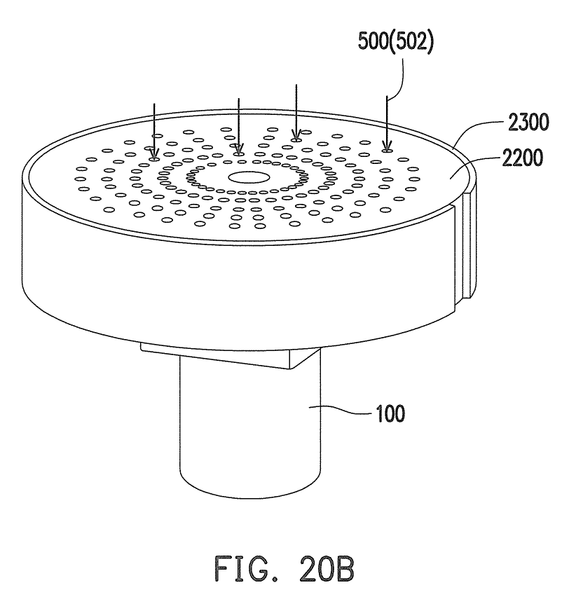

A method of manufacturing the microarray biochip is described below with reference of the aforementioned apparatus. Referring to FIG. 20A, the carrier 2200 is installed on the spinning platen 100. In collaboration with the round plate carrier 2200, a substrate 2300 is designed to be a flexible substrate, and the flexible substrate 2300 is attached to the ring-shape side surface 2200c of the round plate carrier 2200.

Referring to FIG. 20A and FIG. 20B, the sample 500 is injected through the input terminal 2202a of the micro-channel 2202 of the carrier 2200, and the sample 500 is automatically sucked into the micro-channel 2202 based on capillarity. Then, the spinning platen 100 is powered-on to provide a centrifugal force to the carrier 2200, such that the sample 500 in the micro-channel 2202 is flowed towards the output terminal 2202b from the input terminal 2202a of the micro-channel 2202, and the biological molecules or particles 502 in the sample 500 are immobilized on the surface of the substrate 2300.

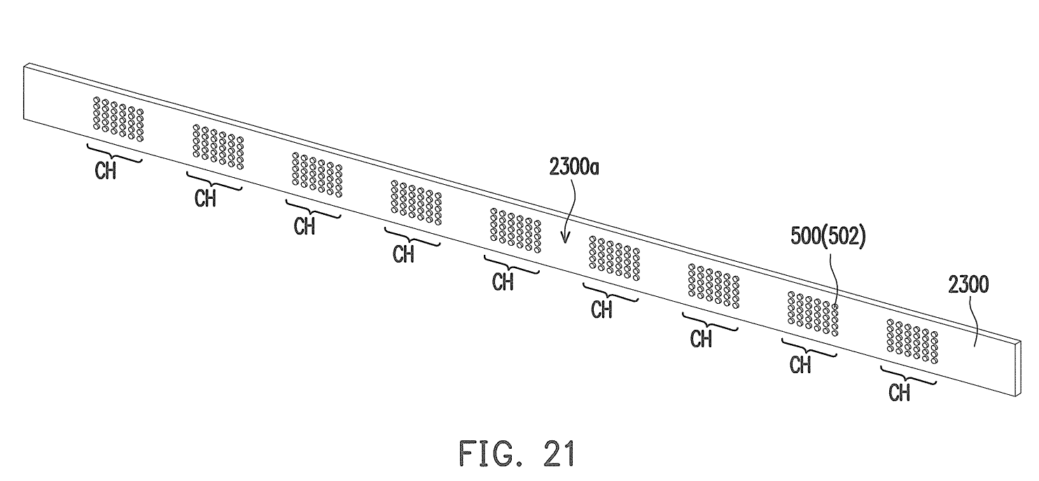

After the above step is completed, the substrate 2300 is taken away from the carrier 2200 to obtain the substrate 2300 shown in FIG. 21. A plurality of regions containing the biological molecules or particles 502 is formed on a surface 2300a of the substrate 2300. The regions containing the biological molecules or particles 502 on the surface 2300a of the substrate 2300 can immobilize different biological molecules or particles or the same biological molecules or particles, which are determined according to an actual application of the microarray biochip. The substrate 2300 comprises a plurality of chip units CH. Finally, the substrate 2300 is cut to obtain a plurality of chips CH as that shown in FIG. 5C.

In the embodiments of FIG. 19, FIG. 20A to FIG. 21B, although the carrier 2200 and the substrate 2300 are directly attached, in other embodiments, a pad can be disposed between the carrier 2200 and the corresponding substrate 2300. Moreover, in other embodiments, the sample 500 can also be injected through the output terminal 2202b of the micro-channel 2202 of the carrier 2200. Then, the sample 500 is automatically sucked into the micro-channel 2202 based on capillarity. Injection of the sample 500 from the output terminal 2202b of the micro-channel 2202 of the carrier 2200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

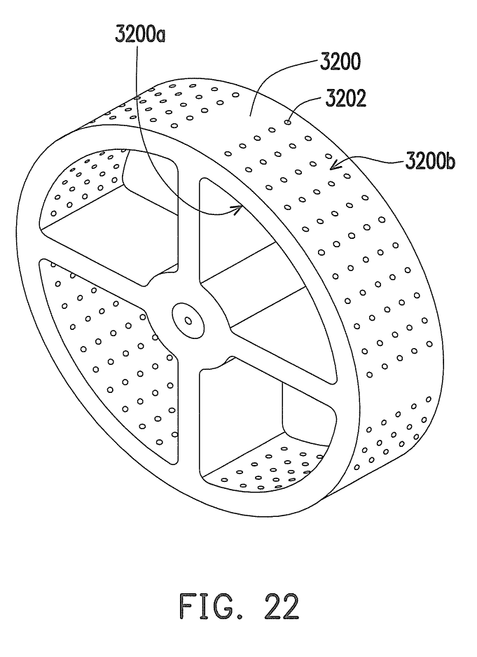

FIG. 22 is a schematic diagram of a carrier according to another exemplary embodiment of the disclosure. Referring to FIG. 22, a structure of the carrier 3200 of FIG. 22 is similar to that of the carrier 2200 of FIG. 19, and a difference there between is that the carrier 3200 is a wheel frame carrier. In other words, the carrier 3200 has a hollow structure. The carrier 3200 comprises a ring-shape inner surface 3200a and a ring-shape outer surface 3200b. Moreover, the carrier 3200 also comprises at least one micro-channel 3202. Similarly, in the carrier 3200, the input terminal of the micro-channel 3202 is located on the ring-shape inner surface 3200a, and the output terminal thereof is located on the ring-shape outer surface 3200b.

Therefore, when the above carrier is used to manufacture the microarray biochip, the sample is injected through the input terminal of the micro-channel 3202 located on the ring-shape inner surface 3200a of the carrier 3200, and the sample is automatically sucked into the micro-channel 3202 based on capillarity. Then, the same as the step of FIG. 20B, the flexible substrate 2300 is attached to the ring-shape outer surface 3200b of the carrier 3200. Then, when the spinning platen 100 is powered-on to provide the centrifugal force to the carrier 3200, the sample 500 in the micro-channel 3202 is flowed towards the output terminal of the micro-channel 3202, and the biological molecules or particles 502 in the sample 500 are immobilized on the surface of the substrate.

In another exemplary embodiment, the sample can also be injected through the output terminal of the micro-channel 3202 located on the ring-shape outer surface 3200b of the carrier 3200, and the sample is automatically sucked into the micro-channel 3202 based on capillarity. Then, the same as the step of FIG. 20B, the flexible substrate 2300 is attached to the ring-shape outer surface 3200b of the carrier 3200. Then, when the spinning platen 100 is powered-on to provide the centrifugal force to the carrier 3200, the sample 500 in the micro-channel 3202 is flowed towards the output terminal of the micro-channel 3202, and the biological molecules or particles 502 in the sample 500 are immobilized on the surface of the substrate.

Similarly, a pad can be further disposed between the carrier 3200 and the substrate 2300.

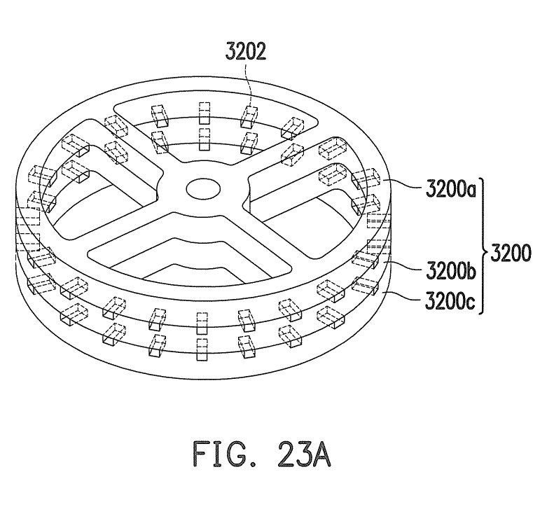

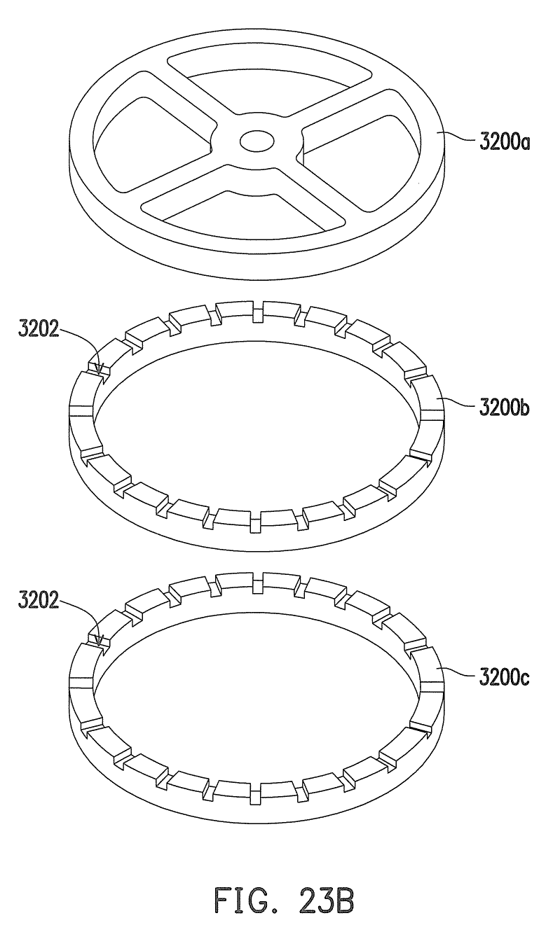

FIG. 23A is a schematic diagram of a carrier according to an exemplary embodiment of the disclosure. FIG. 23B is an exploded view of the carrier of FIG. 23A. Referring to FIG. 23A and FIG. 23B, the wheel frame carrier 3200 of the present embodiment is formed by stacking a top disc 3200a and at least one channel discs 3200b-3200c, and each of the channel discs 3200b-3200c comprises at least one micro-channel 3202. In the present exemplary embodiment, the top disc 3200a does not have the micro-channel. After the top disc 3200a is stacked to the channel discs 3200b-3200c, the carrier 3200 having the micro-channels 3202 is formed.

Regardless of the round plate carrier 2200 or the wheel frame carrier 3200, the micro-channel 2202 (or 3202) thereof can be an L-shape channel shown in FIG. 3A, an L-shape channel comprising a plane chamfer as that shown in FIG. 3B, an L-shape channel comprising an arc chamfer as that shown in FIG. 3C, a straight line channel as that shown in FIG. 3D, an oblique line channel as that shown in FIG. 3E, or a curved line channel as that shown in FIG. 3F.

### Fifth Exemplary Embodiment

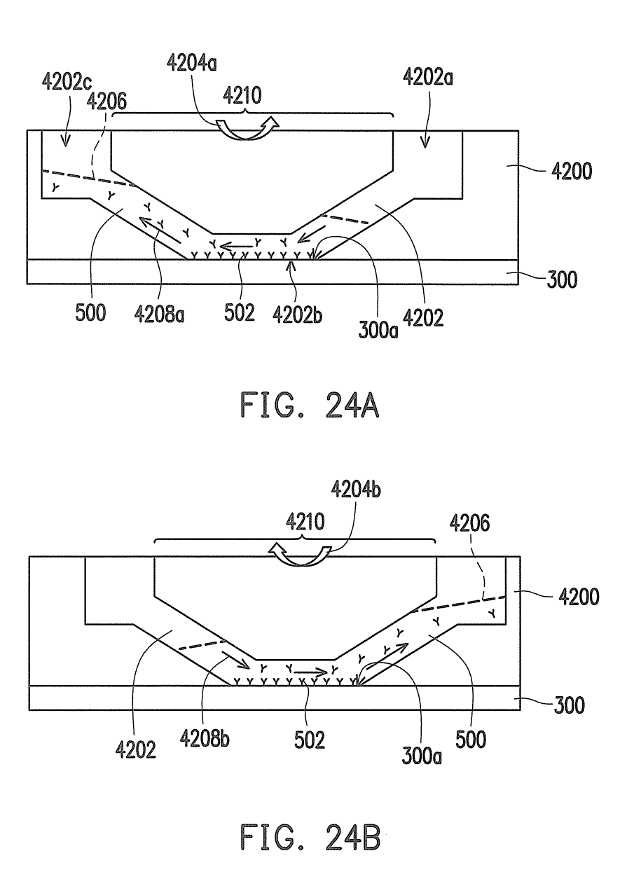

FIG. 24A to FIG. 24B are schematic diagrams of a flow of manufacturing a microarray biochip according to an exemplary embodiment of the disclosure. Referring to FIG. 24A, in the present exemplary embodiment, a carrier 4200 in the apparatus of manufacturing the microarray biochip comprises at least one micro-channel 4202. In the figures of the present exemplary embodiment, a cross-sectional view of a single micro-channel 4202 is taken as an example for descriptions, though the carrier 4200 may actually comprise a plurality of the micro-channels 4202. Here, the micro-channel 4202 is a V-shape channel. One of two terminals of the V-shape channel 4202 is an input terminal 4202a. Moreover, a region between the two terminals of the V-shape channel 4202 is a middle region 4210, and an output terminal 4202b of the micro-channel 4202 is designed in the middle region 4210. According to an embodiment, one of the two terminals of the V-shape channel 4202 serves as the input terminal 4202a, and another terminal serves as a collection area 4202c to collect excess liquid. Moreover, a vent hole can be configured at the collection area 4202c. Similarly, the substrate 300 is attached to the carrier 4200, and the output terminal 4202b of the micro-channel 4202 of the carrier 4200 contacts the surface 300a of the substrate 300. If the collection area 4202c has the vent hole, gas in the V-shape channel 4202 is not accumulated at the output terminal 4202b, i.e. the bubbles do not occupy the output terminal 4202b, so that the sample 500 can completely contact the substrate 300 at the output terminal 4202b.

A method of manufacturing the microarray biochip through the aforementioned carrier 4200 is as follows. First, the carrier 4200 and the substrate 300 are fixed on a spinning platen (for example, the spinning platen 100 of FIG. 1), and then the sample 500 is injected into the V-shape channel 4202 of the carrier 4200 through the input terminal 4202a, and the sample 500 is automatically sucked into the micro-channel 4202 based on capillarity.

Then, the spinning platen is powered on to provide a centrifugal force to the carrier 4200. In the present embodiment, in the step of powering on the spinning platen to provide the centrifugal force to the carrier 4200, a disturbance procedure is performed to the sample 500 in the micro-channel 4202 of the carrier 4200. The disturbance procedure comprises forward and backward rotations of the spinning platen, for example, forward rotation along a rotation direction 4204a of FIG. 24A and backward rotation along a rotation direction 4204b of FIG. 24B, or accelerating and decelerating rotations. According to the disturbance procedure, variation of the sample 500 in the micro-channel 4202, for example, variation of a liquid surface 4206 in FIG. 24A and FIG. 24B is achieved. In other words, according to the above disturbance procedure, the sample 500 can repeatedly scour the micro-channel 4202 (shown as arrows 4208a and 4208b), and the specific biological molecules or particles 502 in the sample 500 can be immobilized on the surface 300a of the substrate 300 through the output terminal 4202b of the micro-channel 4202.

During the above disturbance procedure, the sample 500 and the specific biological molecules or particles 502 in the micro-channel 4202 is functioned by a Coriolis force, an Euler force and the centrifugal force. Therefore, when a rotation parameter of the spinning platen is changed (for example, forward and backward rotations or accelerating and decelerating rotations), the sample 500 and the specific biological molecules or particles 502 located at different positions of the micro-channel 4202 is function by different degrees of the Coriolis force, the Euler force and the centrifugal force, so as to achieve a disturbance effect on the sample 500 and the specific biological molecules or particles 502 in the micro-channel 4202. In this way, the biological molecules or particles 502 in the sample 500 that are not successfully immobilized on the surface 300a of the substrate 300 are taken away from the surface 300a of the substrate 300, and other biological molecules or particles 502 in the sample 500 may have more opportunities to contact the surface 300a of the substrate 300.

In the exemplary embodiment of FIG. 24A and FIG. 24B, although the carrier 4200 and the substrate 300 are directly attached, in other embodiments, a pad can be disposed between the carrier 4200 and the substrate 300. Moreover, in other embodiments, the sample 500 can also be injected through the output terminal 4202b of the micro-channel 4202 of the carrier 4200. Then, the sample 500 is automatically sucked into the micro-channel 4202 based on capillarity. Injection of the sample 500 from the output terminal 4202b of the micro-channel 4202 of the carrier 4200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

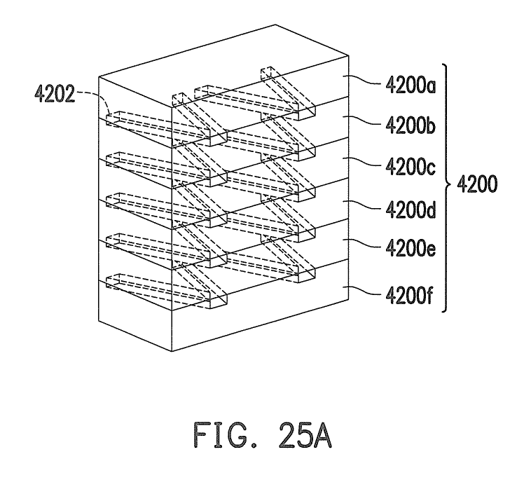

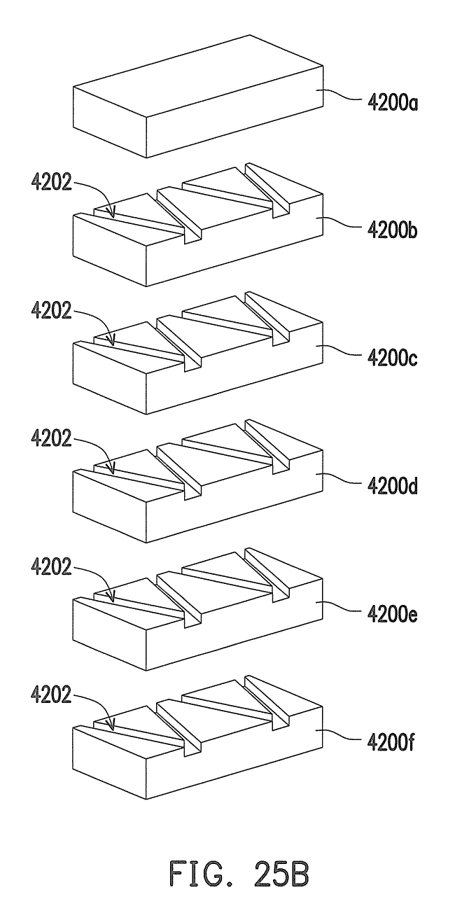

FIG. 25A is a schematic diagram of a carrier according to an exemplary embodiment of the disclosure. FIG. 25B is an exploded view of the plate-type carrier of FIG. 25A. Referring to FIG. 25A and FIG. 25B, the carrier 4200 of the present embodiment is also formed by stacking a top disc 4200a and at least one channel discs 4200b-4200f, and each of the channel discs 4200b-4200f comprises at least one V-shape channel 4202. In the present exemplary embodiment, the top disc 4200a does not have the micro-channel. After the top disc 4200a is stacked to the channel discs 4200b-4200f, the carrier 4200 having the V-shape channels 4202 is formed.

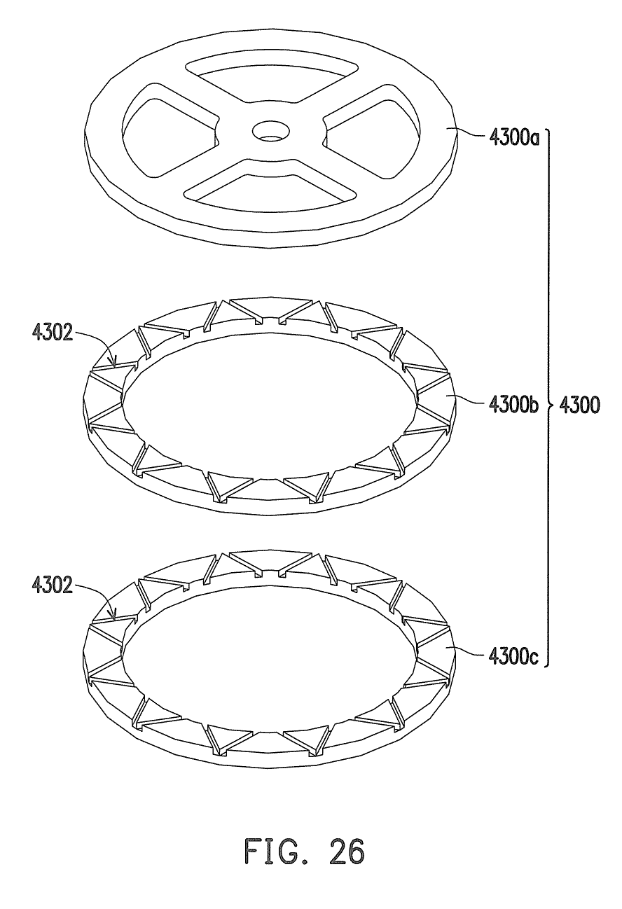

It should be noticed that the V-shape channel of the present exemplary embodiment can also be applied to the wheel frame carrier. As shown in FIG. 26, in another exemplary embodiment, a wheel frame carrier 4300 is formed by stacking a top disc 4300a and at least one channel disc 4300b-4300c, and each of the channel discs 4300b-4300c comprises at least one V-shape channel 4302. After the top disc 4300a is stacked to the channel discs 4300b-4300c, the carrier 4300 having the V-shape channels 4302 is formed.

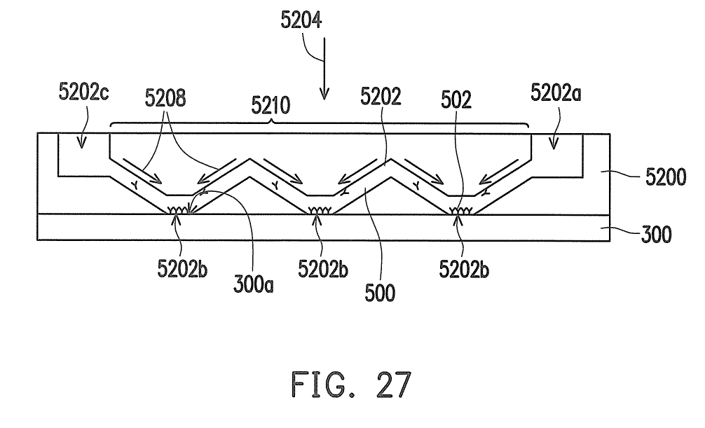

FIG. 27 is a schematic diagram of a flow of manufacturing a microarray biochip according to an exemplary embodiment of the disclosure. Referring to FIG. 27, the present exemplary embodiment is similar to the exemplary embodiment of FIG. 24A and FIG. 24B, and a difference there between is that a micro-channel 5202 of a carrier 5200 is a wave-shape channel. Similarly, a cross-sectional view of a single micro-channel 5202 is taken as an example for descriptions, though the carrier 5200 may actually comprise a plurality of the micro-channels 5202. One of two terminals of the wave-shape channel 5202 is an input terminal 5202a, and another terminal serves as a collection area 5202c to collect excess liquid. Moreover, a vent hole can be configured at the collection area 5202c. Moreover, a region between the two terminals of the wave-shape channel 5202 is a middle region 5210, and a plurality of output terminals 5202b is designed in the middle region 5210. Similarly, the substrate 300 is attached to the carrier 5200, and the output terminals 5202b of the micro-channel 5202 of the carrier 5200 contact the surface 300a of the substrate 300. If the collection area 5202c has the vent hole, gas in the micro-shape channel 5202 is not accumulated at the output terminals 5202b, i.e. the bubbles do not occupy the output terminals 5202b, so that the sample 500 can completely contact the substrate 300 at the output terminals 5202b.

A method of manufacturing the microarray biochip through the aforementioned carrier 5200 is as follows. First, the carrier 5200 and the substrate 300 are fixed on a spinning platen (for example, the spinning platen 100 of FIG. 1), and then the sample 500 is injected into the wave-shape channel 5202 of the carrier 5200 through the input terminal 5202a. Similarly, the sample 500 is automatically sucked into the micro-channel 5202 based on capillarity.

Then, the spinning platen is powered on to provide a centrifugal force 5204 to the carrier 5200. Due to the function of the centrifugal force 5204, the sample 500 moves towards the output terminals 5202b of the micro-channel 5202, and the specific biological molecules or particles 502 in the sample 500 can be immobilized on the surface of the substrate 300.

Similarly, in the present exemplary embodiment, in the step of powering on the spinning platen to provide the centrifugal force to the carrier 5200, a disturbance procedure is performed to the sample 500 in the micro-channel 5202 of the carrier 5200. The disturbance procedure comprises forward and backward rotations of the spinning platen, or accelerating and decelerating rotations. In other words, according to the above disturbance procedure, the sample 500 can repeatedly scour the micro-channel 5202, and the specific biological molecules or particles 502 in the sample 500 can be immobilized on the surface 300a of the substrate 300 through the output terminals 5202b of the micro-channel 5202.

During the above disturbance procedure, the sample 500 and the specific biological molecules or particles 502 in the micro-channel 5202 is functioned by a Coriolis force, an Euler force and the centrifugal force. Therefore, when a rotation parameter of the spinning platen is changed (for example, forward and backward rotations or accelerating and decelerating rotations), the sample 500 and the specific biological molecules or particles 502 located at different positions of the micro-channel 5202 is function by different degrees of the Coriolis force, the Euler force and the centrifugal force, so as to achieve a disturbance effect on the sample 500 and the specific biological molecules or particles 502 in the micro-channel 5202. In this way, the specific biological molecules or particles 502 in the sample 500 that are not successfully immobilized on the surface 300a of the substrate 300 are taken away from the surface 300a of the substrate 300, and other biological molecules or particles 502 in the sample 500 may have more opportunities to contact the surface 300a of the substrate 300.

In the present exemplary embodiment, since the single wave-shape channel 5202 comprises a plurality of the output terminals 5202b, after one rotation step is performed, each of the wave-shape channels 5202 may form a plurality of regions containing the specific biological molecules or particles 502 on the substrate 300. Different wave-shape channels 5202 can be injected with the sample 500 containing the same or different biological molecules or particles 502.

In the exemplary embodiment of FIG. 27, although the carrier 5200 and the substrate 300 are directly attached, in other embodiments, a pad can be disposed between the carrier 5200 and the substrate 300. Moreover, in other embodiments, the sample 500 can also be injected through the output terminals 5202b of the micro-channel 5202 of the carrier 5200. Then, the sample 500 is automatically sucked into the micro-channel 5202 based on capillarity. Injection of the sample 500 from the output terminals 4202b of the micro-channel 5202 of the carrier 5200 can prevent generation of bubbles, so as to avoid the bubbles from influencing an area profile of the specific biological molecules or particles 502 contained in the sample 500 and immobilized on the substrate 300. In this way, the specific biological molecules or particles 502 contained in the sample 500 can be evenly and completely immobilized on the surface 300a of the substrate 300.

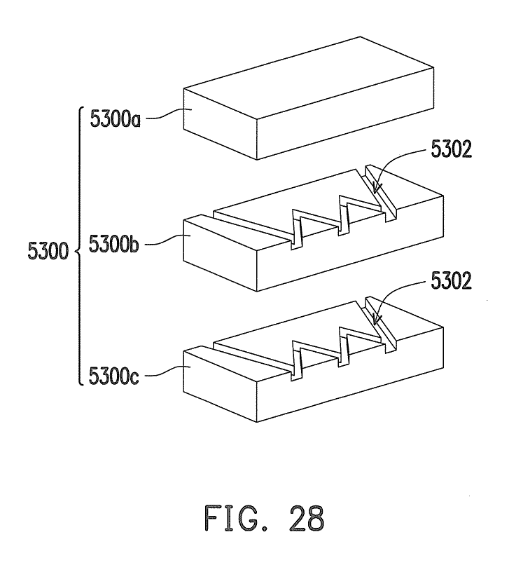

FIG. 28 is an exploded view of a carrier according to an exemplary embodiment of the disclosure, which is an embodiment that the wave-shape channel is applied to the plate-type carrier. Referring to FIG. 28, the carrier 5300 of the present embodiment is also formed by stacking a top disc 5300a and at least one channel discs 5300b-5300c, and each of the channel discs 5300b-5300c comprises at least one wave-shape channel 5302. In the present exemplary embodiment, the top disc 5300a does not have the micro-channel. After the top disc 5300a is stacked to the channel discs 5300b-5300c, the carrier 5300 having the wave-shape channels 5302 is formed.

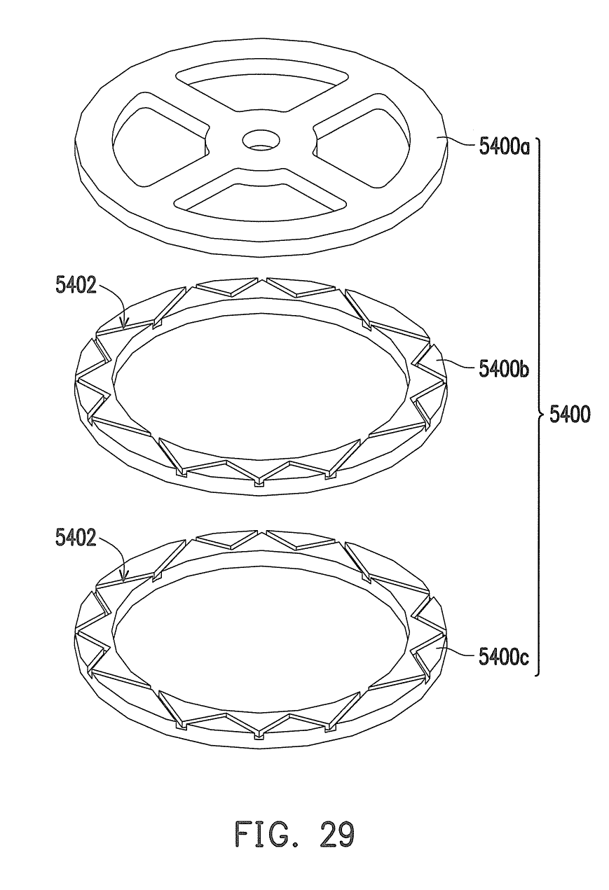

It should be noticed that the wave-shape channel of the present exemplary embodiment can also be applied to the wheel frame carrier. As shown in FIG. 29, in another exemplary embodiment, a wheel frame carrier 5400 is formed by stacking a top disc 5400a and at least one channel disc 5400b-5400c, and each of the channel discs 5400b-5400c comprises at least one wave-shape channel 5402. After the top disc 5400a is stacked to the channel discs 5400b-5400c, the carrier 5400 having the wave-shape channels 5402 is formed.

In summary, under a function of the centrifugal force, the sample is flowed to the output terminal of the micro-channel from the input terminal thereof, and is concentrated at the output terminal. In this way, a concentration of the sample contacting the surface of the chip is enhanced to greatly shorten a time required for successfully immobilizing the sample on the chip, so as to achieve a high density spotting effect. Meanwhile, by applying a specific micro-channel structure, a scouring effect can be achieved to improve evenness of immobilization.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An apparatus of manufacturing a microarray biochip, comprising:
a spinning platen;
at least one carrier, fixed on the spinning platen and comprising at least one micro-channel having an input terminal and an output terminal; and
at least one substrate, attached to the output terminal of the micro-channel of the carrier.

2. The apparatus of manufacturing the microarray biochip as claimed in claim 1, wherein the micro-channel is an L-shape channel, an L-shape channel comprising a plane chamfer, an L-shape channel comprising an arc chamfer, a straight line channel, an oblique line channel, or a curved line channel.

3. The apparatus of manufacturing the microarray biochip as claimed in claim 1, further comprising a pad located between the carrier and the substrate, wherein the pad comprises at least one through via communicating with the micro-channel of the carrier.

4. The apparatus of manufacturing the microarray biochip as claimed in claim 1, wherein the carrier is a block carrier having an upper surface, a lower surface and a plurality of side surfaces, the input terminal of the micro-channel is located on the upper surface, and the output terminal of the micro-channel is located on one of the side surfaces.

5. The apparatus of manufacturing the microarray biochip as claimed in claim 4, wherein the carrier is formed by stacking a top disc and at least one channel disc, the top disc comprises at least one injection hole, the channel disc comprises at least one injection opening and at least one flowing channel, and the injection hole of the top disc and the injection opening and the flowing channel of the channel disc form the micro-channel of the carrier.

6. The apparatus of manufacturing the microarray biochip as claimed in claim 1, wherein the carrier is a round plate carrier having an upper surface, a lower surface and a ring-shape side surface, the substrate is a flexible substrate and is attached to the ring-shape side surface of the round plate carrier, the input terminal of the micro-channel of the round plate carrier is located on the upper surface, and the output terminal is located on the ring-shape side surface.

7. The apparatus of manufacturing the microarray biochip as claimed in claim 6, wherein the carrier is formed by stacking a top disc and at least one channel disc, the top disc comprises at least one injection hole, the channel disc comprises at least one injection opening and at least one flowing channel, and the injection hole of the top disc and the injection opening and the flowing channel of the channel disc form the micro-channel of the carrier

8. The apparatus of manufacturing the microarray biochip as claimed in claim 6, wherein the micro-channel is an L-shape channel, an L-shape channel comprising a plane chamfer, an L-shape channel comprising an arc chamfer, a straight line channel, an oblique line channel, or a curved line channel.

9. The apparatus of manufacturing the microarray biochip as claimed in claim 1, wherein the carrier is a plate-type carrier, and the plate-type carrier comprises at least one through via serving as the micro-channel of the carrier.

10. The apparatus of manufacturing the microarray biochip as claimed in claim 9, wherein the carrier is formed by stacking a top disc and at least one channel disc, and the channel disc comprises at least one micro-channel.

11. The apparatus of manufacturing the microarray biochip as claimed in claim 1, wherein the carrier is a wheel frame carrier comprising a ring-shape inner surface and a ring-shape outer surface, and the substrate is a flexible substrate and is attached to the ring-shape outer surface of the wheel frame carrier.

12. The apparatus of manufacturing the microarray biochip as claimed in claim 11, wherein the carrier is formed by stacking a top disc and at least one channel disc, and the channel disc comprises at least one micro-channel.

13. The apparatus of manufacturing the microarray biochip as claimed in claim 1, wherein the micro-channel is a V-shape channel, and an input terminal thereof is located at one of two terminals of the V-shape channel, and an output terminal thereof is located at a middle region of the V-shape channel.

14. The apparatus of manufacturing the microarray biochip as claimed in claim 13, wherein one of the two terminals of the V-shape channel is the input terminal and another terminal is a collection area, and the collection area comprises a vent hole.

15. The apparatus of manufacturing the microarray biochip as claimed in claim 13, wherein the carrier is formed by stacking a top disc and at least one channel disc, and the channel disc comprises at least one V-shape channel.

16. The apparatus of manufacturing the microarray biochip as claimed in claim 15, wherein the carrier is a plate-type carrier or a wheel frame carrier.

17. The apparatus of manufacturing the microarray biochip as claimed in claim 1, wherein the micro-channel is a wave-shape channel, and an input terminal thereof is located at one of two terminals of the wave-shape channel, and a middle region of the wave-shape channel comprises at least one output terminal.

18. The apparatus of manufacturing the microarray biochip as claimed in claim 17, wherein one of the two terminals of the wave-shape channel is the input terminal and another terminal is a collection area, and the collection area comprises a vent hole.

19. The apparatus of manufacturing the microarray biochip as claimed in claim 17, wherein the carrier is formed by stacking a top disc and at least one channel disc, and the channel disc comprises at least one wave-shape channel.

20. The apparatus of manufacturing the microarray biochip as claimed in claim 19, wherein the carrier is a plate-type carrier or a wheel frame carrier.

21. A method of manufacturing a microarray biochip, comprising:
providing at least one carrier, wherein the carrier comprises at least one micro-channel, and the micro-channel has an input terminal and an output terminal;
attaching at least one substrate to the carrier, wherein the substrate is attached to the output terminal of the micro-channel of the carrier;
injecting a sample into the micro-channel through the input terminal or the output terminal of the carrier;
fixing the carrier and the substrate to a spinning platen; and
powering on the spinning platen to provide a centrifugal force to the carrier, such that the sample is immobilized on a surface of the substrate through the output terminal of the micro-channel.

22. The method of manufacturing the microarray biochip as claimed in claim 21, further comprising disposing a pad between the carrier and the substrate, wherein the pad comprises at least one through via communicating with the micro-channel of the carrier.

23. The method of manufacturing the microarray biochip as claimed in claim 21, wherein the at least one carrier comprises a plurality of carriers, and the at least one substrate comprises a plurality of substrates, and each of the substrates is attached to a corresponding carrier.

24. The method of manufacturing the microarray biochip as claimed in claim 21, wherein the at least one carrier is formed by stacking a top disc and a plurality of channel discs.

25. The method of manufacturing the microarray biochip as claimed in claim 24, wherein the carrier is a block carrier, a plate-type carrier, a round plate carrier or a wheel frame carrier.

26. The method of manufacturing the microarray biochip as claimed in claim 25, wherein the micro-channel is an L-shape channel, an L-shape channel comprising a plane chamfer, an L-shape channel comprising an arc chamfer, a straight line channel, an oblique line channel, or a curved line channel.

27. The method of manufacturing the microarray biochip as claimed in claim 21, wherein the carrier is a round plate carrier or a wheel frame carrier, and the substrate is a flexible substrate.

28. The method of manufacturing the microarray biochip as claimed in claim 21, wherein the step of powering on the spinning platen further comprises performing a disturbance procedure to the sample in the micro-channel.

29. The method of manufacturing the microarray biochip as claimed in claim 28, wherein the disturbance procedure comprises forward and backward rotations or accelerating and decelerating rotations of the spinning platen.

30. The method of manufacturing the microarray biochip as claimed in claim 21, wherein the micro-channel is a V-shape channel, and the output terminal is located at a middle region of the V-shape channel, and when the spinning platen is powered on, the sample is immobilized on the surface of the substrate through the output terminal.

31. The method of manufacturing the microarray biochip as claimed in claim 21, wherein the micro-channel is a wave-shape channel, and a middle region of the wave-shape channel comprises a plurality of output terminals, and when the spinning platen is powered on, the sample is immobilized on the surface of the substrate through the output terminals.

32. The method of manufacturing the microarray biochip as claimed in claim 21, wherein the sample is a biological sample, the surface of the substrate is a treated surface, and after the spinning platen is powered on, the biological sample is immobilized on the treated surface of the substrate.

33. The method of manufacturing the microarray biochip as claimed in claim 21, wherein the sample is a surface treatment reagent, and after the spinning platen is powered on, the surface treatment reagent is immobilized on or reacted with the surface of the substrate.
